(19) United States
(12) Patent Application Publication
(10) Pub. No.: US 2007/0100743 A1
(43) Pub. Date: May 3, 2007

(54) Computer system for the management of loans

(76) Inventors: Mark James Walter Barge, Staines (GB); David Acheson Lloyd, Staines (GB)

Correspondence Address: BAKER & BOTTS L.L.P., 30 ROCKEFELLER PLAZA, 44TH FLOOR, NEW YORK, NY, 10112-4498, US

(21) Appl. No.: 10/560,697

(22) PCT Filed: Apr. 22, 2003
(86) PCT No.: PCT/GB03/01698

§ 371 Date: Sep. 28, 2006

(30) Foreign Application Priority Data
Apr. 19, 2002 (GB) 0209021.5
Sep. 9, 2002 (GB) 0220882.5

(51) Int. Cl. G06Q 40/00

(52) U.S. Cl. 705/38

(57) ABSTRACT

A loan management system, which may be used to manage mortgages, includes a mortgage arrangement or “product” definition means for defining different data processing operations to be performed on different mortgages. Different sets of control data may be provided in, or linked to, the product definition means so as to control transactions relating to the product in a manner defined by the corresponding control data. In this way, transactions on different mortgages may be handled in different ways. Using the system it is possible to set up and manage many different kinds of offset—type mortgage arrangements in which the values of funds defined internally in the computer system may vary, for example in accordance with outside indices, and may be offset against outstanding capital and/or interest in a variety of different ways in different mortgages managed by the system.

This invention relates to a computer system for the management of loans. It is particularly concerned with a mortgage management system for use by financial institutions, such as mortgage companies.

Traditionally, mortgages have either been a simple repayment mortgage or an endowment mortgage.

In repayment mortgages, the amount borrowed is repaid by regular instalments, for example monthly, over an agreed period of time. The interest rate may be fixed or variable and the monthly payments are used to pay off both interest and capital. In an endowment mortgage, an endowment insurance policy is arranged with a view to ensuring that the capital sum which is realised when the endowment policy matures is at least sufficient to pay off the capital. The mortgagee makes regular monthly payments to pay off the interest on the amount borrowed, which again may be a fixed or variable rate, and to pay the premium for the endowment insurance policy. Relatively simple computer systems can be used to manage repayment mortgages or the “interest only loan” element of an endowment mortgage.

More recently, offset mortgages have been introduced in which money in a savings account is offset against the capital in an associated mortgage and the interest earned on the savings account offset against the interest due on the mortgage account. The interest earned on the deposit account is normally at the same rate as the interest due on the mortgage account. When the characteristics of an offset mortgage are restricted in this way it can be administered by relatively simple computer systems (as explained below).

The offset mortgage comprises two elements, liabilities (the loan) and assets (for example a deposit account). Interest accrues on the liabilities, some return is earned on the assets and transactions take place both in relation to the liabilities and in relation to the assets. However, current mortgage management computer systems are set up only to process the liability element and so offset mortgages are administered by offsetting the asset amount against the loan's capital amount, typically by the creation of a bridge to a savings administration system that collects the asset amount which is to be offset. In this way the loan interest accrues on a smaller amount and is thus reduced and no interest is earned or added to the deposit account balance held on the savings system. This approach restricts both the nature of the assets within an offset mortgage, by definition, to a deposit account and the nature of the transactions that can be executed by the computer system or systems.

The simplicity of currently available mortgage management computer systems, therefore, severely restricts the kinds of offset mortgage arrangements which can be set up and administered.

The problem facing the computer programmer is to devise an improved program for the management of mortgages, which has substantially enhanced flexibility and has the ability to handle efficiently a wide range of different mortgage arrangements, including much more complex offset mortgages and the transactions which are involved in managing them.

This problem is solved by the present invention, at least in preferred embodiments, by means of novel database structures and novel functionality.

A mortgage management system according to one aspect of the invention includes a mortgage arrangement or “product” definition means for defining different data processing operations to be performed on different mortgages. Different sets of control data may be provided in, or linked to, the product definition means so as to control transactions relating to the product in a manner defined by the corresponding control data. In this way, transactions on different mortgages may be handled in different ways.

A mortgage management system according to another aspect of the invention includes means for defining a plurality of internal funds and means for varying the values thereof, for example in accordance with outside indices.

Using the system according to this aspect of the invention, it is possible to set up and manage many different kinds of offset—type mortgage arrangements in which the values of funds defined internally in the computer system may vary, for example in accordance with outside indices, and may be offset against outstanding capital and/or interest in a variety of different ways in different mortgages managed by the system.

A mortgage management system according to a further aspect of the invention comprises a transaction storage means which is of novel structure and/or is arranged to store data relating to transactions in a novel form. The novel structure of the transaction storage means and/or the novel form of the data stored therein may substantially facilitate the performance of complex transactions by the computer.

The invention is described further by way of example with reference to the accompanying drawings in which:

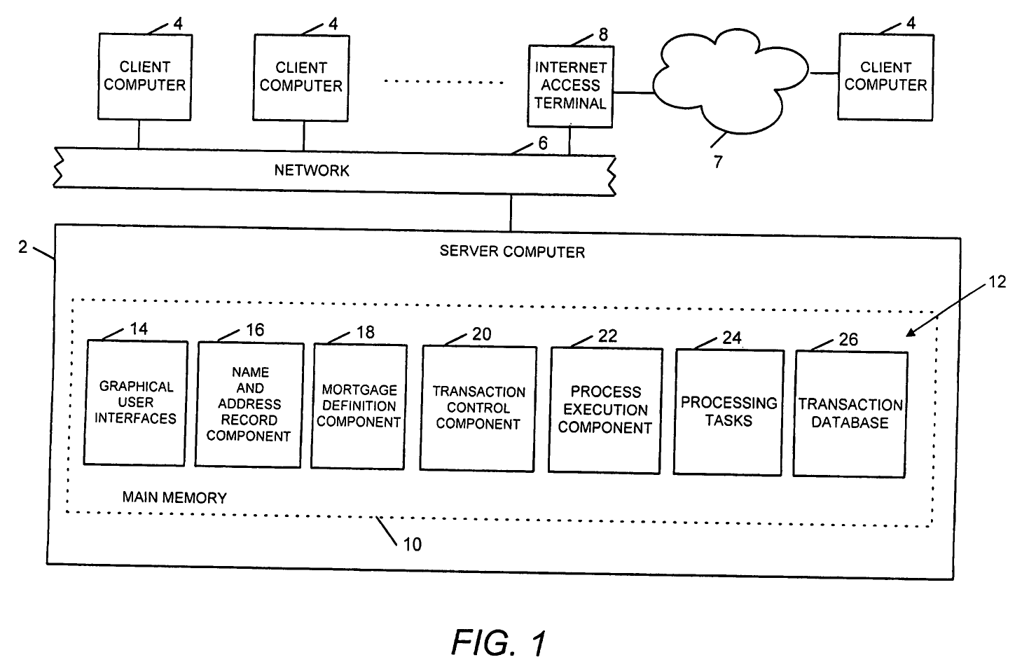

FIG. 1 is a diagrammatic representation of a computer system containing a program in accordance with an embodiment of the invention, with the main components of the program represented in block diagram form;

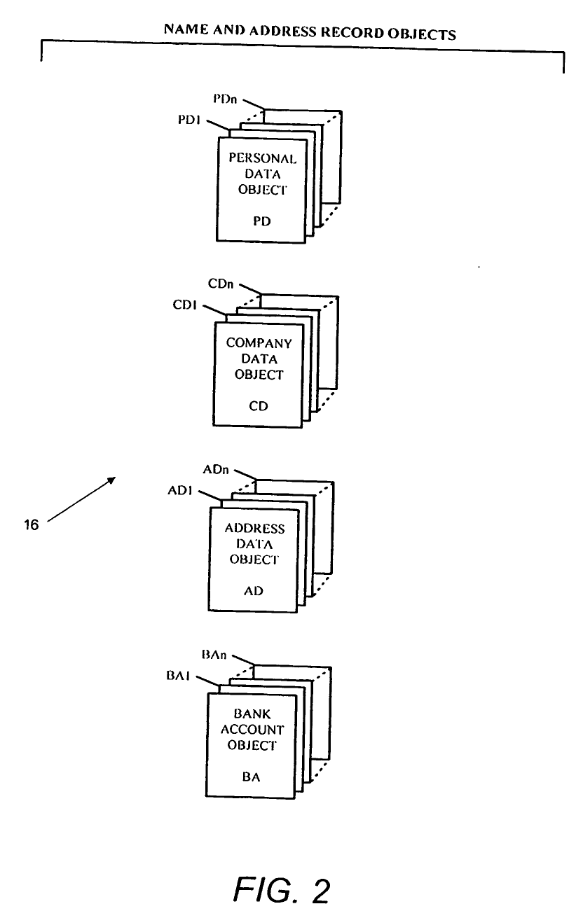

FIG. 2 is a diagrammatic representation of a group of name and address record objects which, in the preferred embodiment, form one of the components shown in FIG. 1;

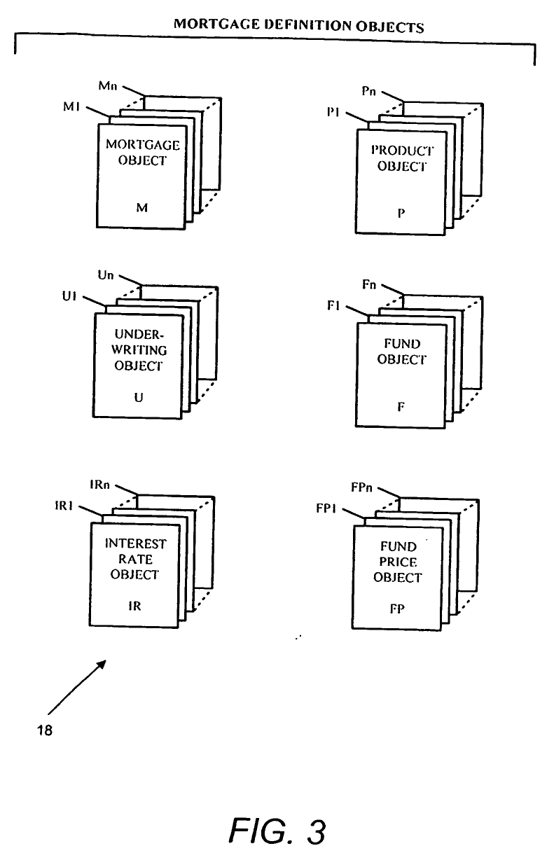

FIG. 3 is a diagrammatic representation of a group of mortgage definition objects which, in the preferred embodiment, form another component shown in FIG. 1;

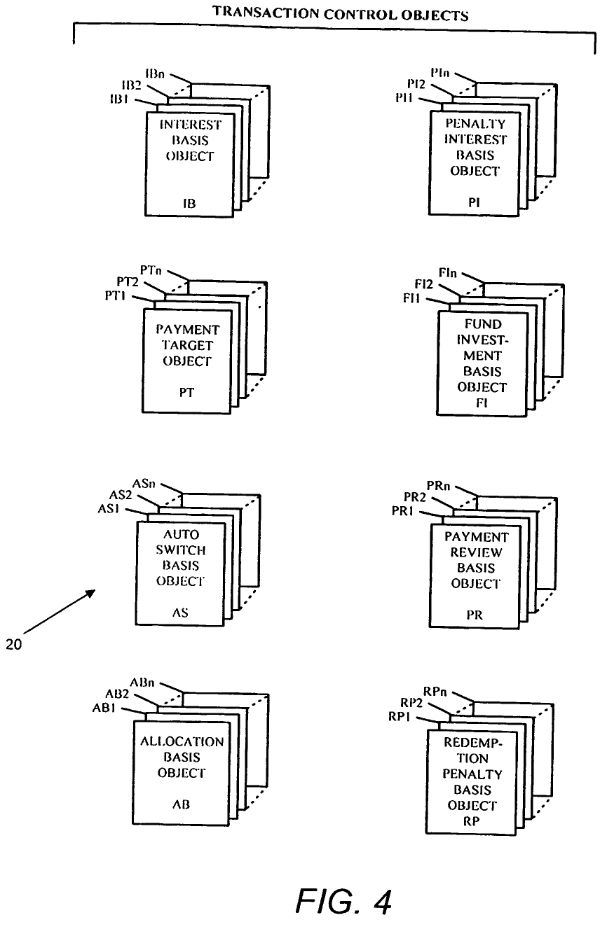

FIG. 4 is a diagrammatic representation of a group of transaction control objects which, in the preferred embodiment, form another of the components shown in FIG. 1;

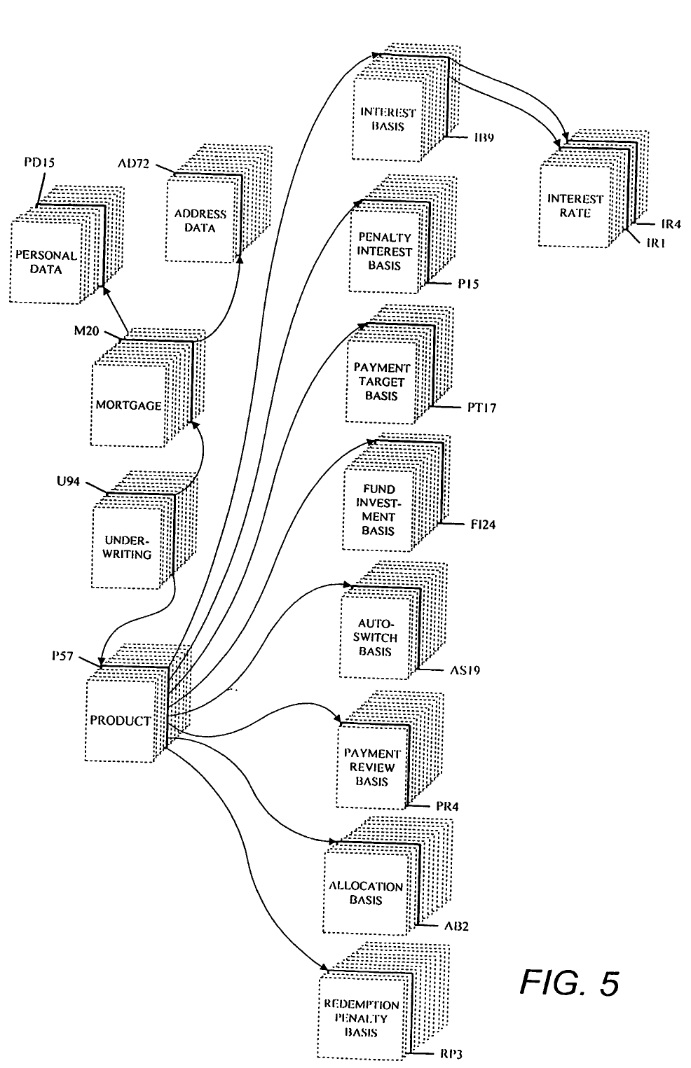

FIG. 5 is a conceptual representation of linkages between the transaction control objects of FIG. 4 and the mortgage definition objects of FIG. 3, to illustrate the way in which different mortgage arrangements are defined and controlled in the system of FIG. 1;

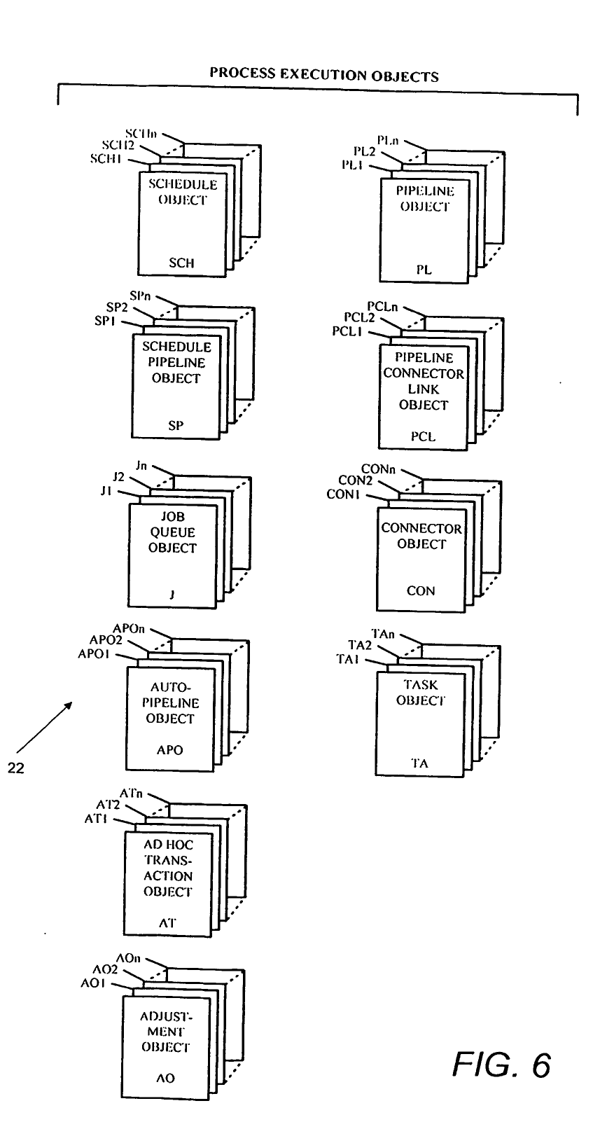

FIG. 6 is a diagrammatic representation of a group of process execution objects which, in the preferred embodiment, form a further one of the components shown in FIG. 1;

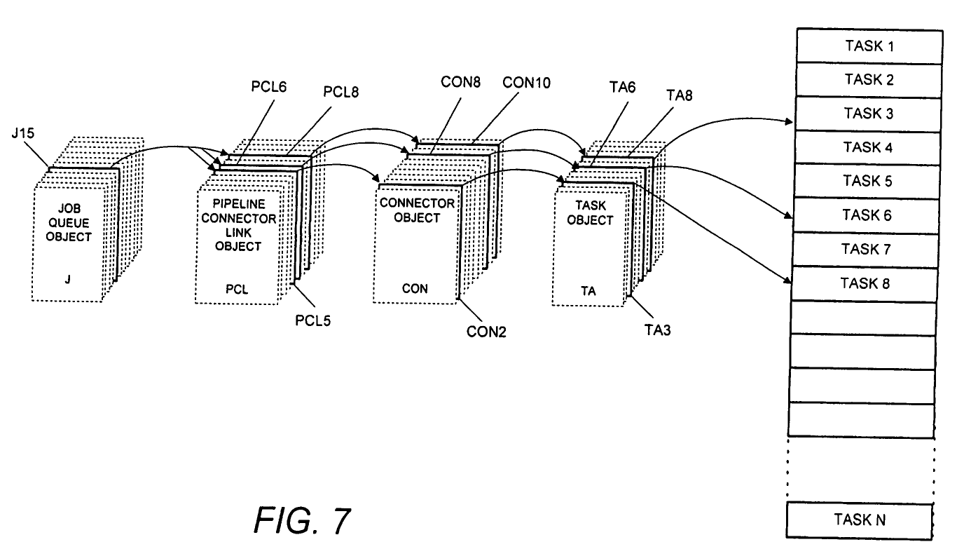

FIG. 7 comprises a diagrammatic representation of a set of processing tasks which form a further one of the components shown in FIG. 1, and a conceptual representation of the manner in which, in the preferred embodiment, a group of these tasks is selected by certain of the objects shown in FIG. 6 for the performance of a transaction;

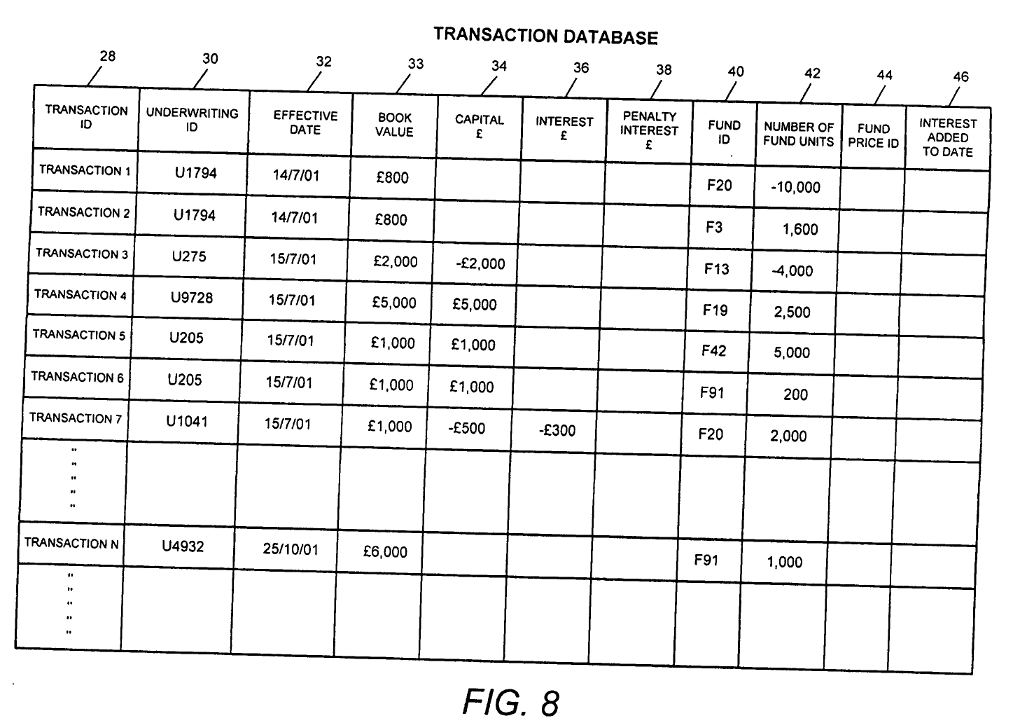

FIG. 8 is a diagrammatic representation of a transaction database which constitutes a further component of FIG. 1;

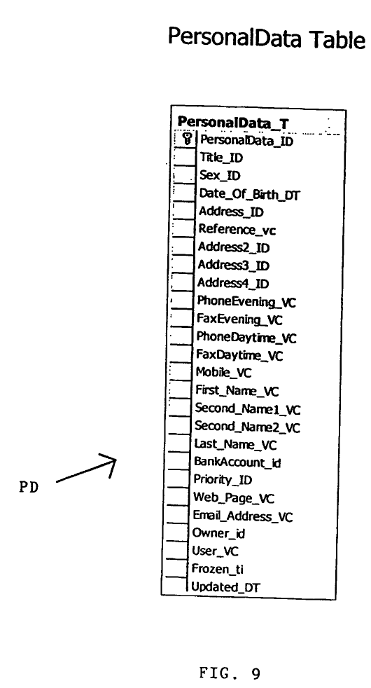

FIGS. 9 to 33 respectively show detailed examples of tables which may be comprised in the objects shown in FIGS. 3 to 8;

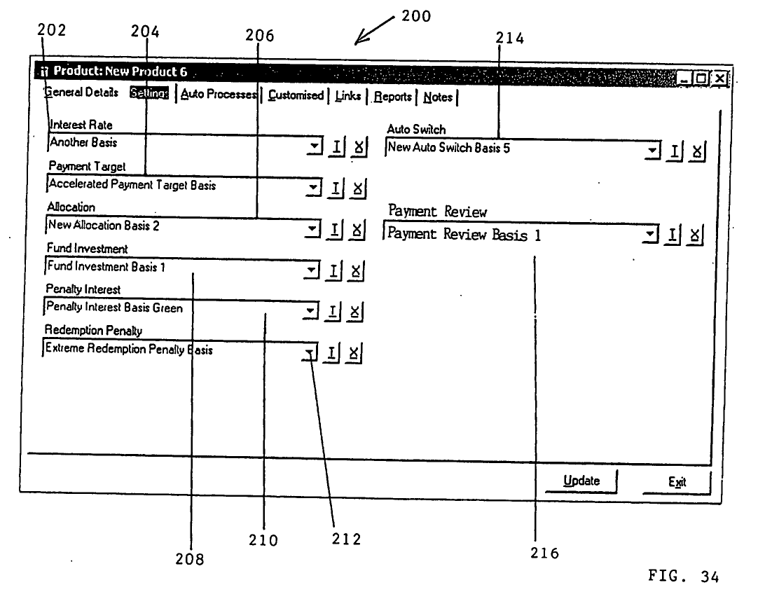

FIGS. 34 to 46 illustrate a number of user interfaces suitable for entering control data into the transaction control objects of FIG. 4, when setting up or amending mortgage arrangements; and

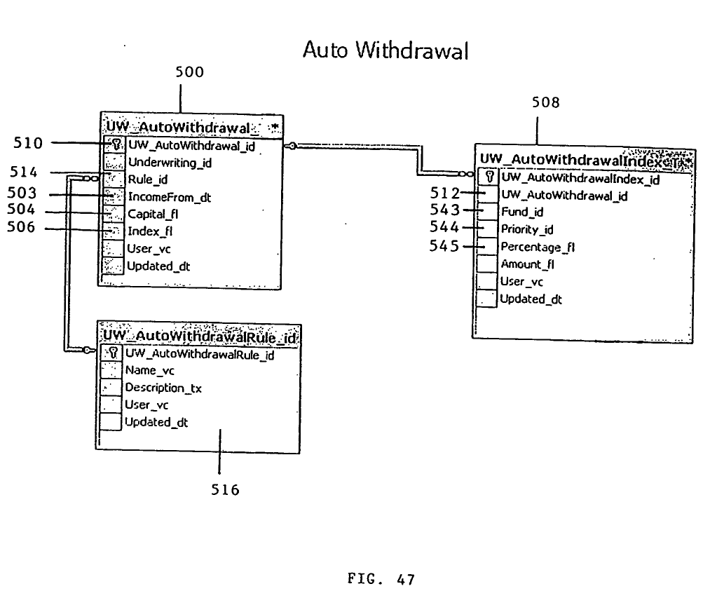

FIGS. 47 to 49 illustrate some additional facilities which may be provided in the preferred embodiment of the invention.

### OVERVIEW OF SYSTEM

FIG. 1 shows a computer system for the management of mortgages comprising a server computer 2 and a number of client computers 4 which may communicate with the server computer 2. For this purpose, the computer 2 is connected to a conventional local area network 6 to which some of the client computers 4 are directly connected. Others of the client computers 4 may communicate with the server computer 2 via the internet 7 and an internet access terminal 8 which is directly connected to the network 6. The internet access terminal 8 is also used, in this embodiment, for collecting from the internet certain data which is to be used in the mortgage management system and which will be described later.

The computers 2 and 4 and the internet access terminal 8 are conventional electronic digital computers made up of the usual components such as a CPU, a main memory such as a hard disk, a random access memory and the usual peripheral units such as a keyboard and mouse for inputting data, a display and printer for outputting data, and network cards and modems as appropriate, none of which need be shown or described in detail.

All of the computers referred to above are provided with a conventional operating system, such as Windows (not shown in the drawings). In addition, the server computer has stored in its main memory, indicated by broken lines 10, a mortgage management application program 12. This may have been stored in the memory in any of a variety of different ways, for example by being created in situ, or by transfer from a data carrier such as an optically or magnetically readable storage medium or an electrical carrier transmitted to the server computer 2 from a remote location via any suitable communication means, such as the internet. The invention extends to data carriers of any type carrying the mortgage management application program or novel components thereof.

The application program 12 is constructed, in this embodiment, utilising an object oriented architecture and comprises seven major components 14, 16, 18, 20, 22, 24, and 26.

Component 14 comprises a set of graphical user interfaces which can be called up by the client computers 4 for entering data into the system, instructing the processing of data and obtaining data from the system, for example for display. A number of these graphical user interfaces will be described later.

Component 16 comprises a group of objects for storing name and address details.

Component 18 comprises a group of objects for defining individual mortgages.

Component 20 comprises a group of objects which store data used for controlling data processing operations involving financial transactions performed in relation to the mortgages handled by the system. Different instances of these objects may store different values for the control data and may be linked to different instances of the mortgage definition objects of component 18, so that when data processing operations are executed the data manipulation which takes place may differ for different mortgages.

As will be more fully explained later, components 18 and 20 are so constructed that a wide range of different mortgage arrangements, particularly a wide range of offset-type mortgages, can be set up with ease. This permits individual mortgage arrangements to be tailored to the requirements of individual mortgagees and mortgagors. As will also be more fully explained later, the structure of components 18 and 20 (and other features of the embodiment) enable the execution easily and quickly of data processing operations, in relation to the wide range of offset type mortgages which can be defined, which are impossible, or at least difficult, with prior art mortgage management computer systems.

The component 22 comprises a group of objects which cause execution of the data processing operations which take place in the system, either in response to preset schedules or in response to ad-hoc instructions which may be input from the client computers 4. These data-processing operations include the financial transactions performed on the mortgages managed by the system. The most important of these transactions are controlled by the control data stored in the objects included in component 20.

Component 24 comprises segments of computer executable code, each segment defining a specific task. The combination of tasks which is required for the performance of respective different data processing operations is called by component 22 as required.

When data processing operations involving financial transactions are executed, the relevant tasks obtain the relevant control data from the objects in components 18 and 20. The instances of these objects from which the control data is to be obtained are identified by identification data stored in component 20, so that the financial transactions are executed in accordance with the requirements of the mortgage to which they relate. This identification data is pre-stored in component 20 in relation to scheduled transactions. In the case of ad hoc transactions, the identification data is inserted into component 20 when the ad hoc transaction is instructed by a user of the system via the appropriate user interface.

Component 26 is a database for recording the transactions which take place. As will be more fully explained below, the structure and content of this database is an important factor in achieving speed of execution of a wide range of different processing operations which the system can perform, particularly financial transactions in relation to the variety of offset type mortgages handled by the system.

### OVERVIEW OF THE NAME AND ADDRESS RECORD OBJECTS

With reference to FIG. 2, component 16 comprises four objects, namely a personal data object PD, a company data object CD, an address data object AD and a bank account object BA. Each of these objects contains a number of fields (to be described later) for storing the relevant data and, in accordance with the principles of object-oriented programming, an individual instance of each of these objects is created for each person, company, address or bank account respectively. The individual instances of these objects are indicated in FIG. 2 by the suffixes 1 to n.

Thus, the reference characters PD1 to PDn indicate respectively instances of the personal data object PD which together contain the personal details of all of the different persons recorded in the mortgage management system, including mortgagees and individuals such as financial advisers or lawyers. Reference characters CD1 to CDn similarly represent different instances of the company data object CD containing respectively details of the different companies recorded in the system.

The objects PD and CD do not contain actual addresses but rather pointers to the appropriate instance AD1 to ADn of the address data object AD, which contain all address data stored on the system, including residences of individuals and properties which are mortgaged, which of course are not necessarily the same in the case of a particular individual having a particular mortgage. Similarly, details of individual bank accounts stored on the system are contained respectively in the different instances BA1 to BAn of bank account object BA.

### OVERVIEW OF THE MORTGAGE DEFINITION OBJECTS

As shown in FIG. 3, there are six objects in component 18 for defining mortgages. Each has a number of fields which will be described more fully later and, as in the case of the objects shown in FIG. 2, each object has a number of instances designated by the suffixes 1 to n.

Mortgage Object

The individual instances M1 to Mn of mortgage object M each relate to, and contain details identifying, a respective different mortgage. Thus, every mortgage which the system manages has its own individual instance of the mortgage object M. The principal details recorded in the instances of the mortgage object M are the identity of the or each mortgagee, the identity of the mortgaged property, and the identity of a bank account from which payments are to be drawn. These identities are defined by the identities of the corresponding instances of the personal data object PD, the address data object AD and the bank account object BA i.e. by pointers.

Underwriting Object

Every mortgage has to be underwritten. For the purpose of recording and managing underwritings, the system includes underwriting object U having instances U1 to Un. Each instance relates to a respective individual underwriting and stores various details including the amount underwritten (i.e. the amount which may be borrowed), the amount of the regular payments which the mortgagee is to make, and the expected final repayment date.

Each instance U1 to Un of the underwriting object U relates to only one mortgage and hence contains the identity of the relevant instance of the mortgage object M. Some mortgages may involve more than one underwriting, for example where during the course of a given mortgage the mortgagee requires a further loan. In these circumstances, a new instance of the underwriting object U is created for the new loan.

In this embodiment of the invention, the mortgage object M does not contain the identity of the instance or instances of the underwriting object U which relate to it. Instead, each instance of the underwriting object U contains the identity of the instance of the mortgage object to which it relates, thereby linking the instance of the underwriting object to the instance of the mortgage object to which it relates.

In addition, each instance of the underwriting object U is linked, either directly or through an instance of the product object P described below, to instances of the transaction control objects of component 20. These contain, as will be more fully described later, control data which governs the performance of financial transactions in relation to the underwriting objects. Users of the system may select, via user interfaces (to be described later) included in component 14, the values of the control data inserted in the objects of component 22 so that transactions performed in relation to different instances of the underwriting object U may differ from each other.

Thus, by linking different instances of the underwriting object U to different instances of the transaction control objects of component 20 and inserting appropriate values for the control data therein, it is possible to set up a variety of different mortgage arrangements.

For example, one instance of the underwriting object U might be set up to provide a simple repayment mortgage and another a simple offset mortgage. Others might be set up to define a variety of different complex offset-type mortgages. Individual bespoke or one-off arrangements can be set up for individual instances of the underwriting object when required.

Product Object

As has already been explained, the invention permits a wide range of different mortgage arrangements to be set up and managed. The present embodiment has facilities for setting up in advance and/or when required a variety of different mortgage arrangements or “products” from which a particular arrangement or “product” can be selected, via an appropriate user interface which can be called up by any of the client computers 4, for example when setting up a new mortgage or new underwriting in relation to an existing mortgage.

For this purpose, component 18 includes a product object P, different instances P1 to Pn of which define respective different arrangements or “products”.

Each instance of the product object P will be linked to instances of the transaction control objects of component 20. As briefly explained above, these contain control data having user selectable values which govern the performance of financial transactions performed by the system. In this way, many different products may be pre-defined, including (as will be more fully explained later) many variations of complex offset-type mortgages.

When a mortgage is to be set up using a pre-defined product, the appropriate instance of the product object P is selected by the user and linked to the appropriate instance of the underwriting object so that transactions in relation to that underwriting object are controlled by the values of the control data in the instances of the transaction control objects to which the particular instance of the product object P is linked.

The preferred embodiment is arranged so that the predefined links between the fields of the product object and instances of the transaction control objects are overridden individually by entering links to different instances of the transaction control objects the relevant fields of the instance of the underwriting object U. In this way, changes in individual items of control data can be made to meet specific requirements of a specific mortgage without making any changes to the preset product which is employed.

An important advantage of components 18 and 20 is that many different instances of the underwriting object U may be set up and different fields thereof linked either directly or via any one of many different instances of the product object P, to any of many different instances of the transaction control objects of component 20, containing different values of the control data. In this way it is possible to define a wide variety of different mortgage arrangements, especially complex offset-type mortgages in which many different offsetting arrangements may be provided.

Fund Object and Fund Price Object

In order to facilitate the creation and management of a wide variety of complex offset-type mortgages, component 18 includes a fund object F, different instances F1 to Fn of which identify different funds employed in the offset-type mortgage arrangements.

In this embodiment, these funds are internal to the program 12 and are not real funds in which mortgagees actually invest. However, the funds have values which may vary with time. An important feature of this embodiment of the invention is that the value of the internal funds is not restricted, so that they may be caused to vary in accordance with virtually any selected criterion. For example, this value may be caused to follow variations in the values of external indices such as the FT-SE 100 index, the retail price index or the price of shares in particular companies. For convenience, those internal funds having values linked to external indices will be identified in the embodiment by the name of the external index to which they are linked. Alternatively, some or all of the internally defined funds may be caused to vary in value in accordance with an internal user defined index whose value varies on some user defined basis. Another possibility is for an internally defined fund to be arranged so that its value varies as some function of a combination of external and/or internal indices, such as the average value of the shares of a combination of different corporations.

The use of these internal funds enables mortgagees to expose a proportion of the borrowed capital and/or proportions of sums which are paid in on a regular or ad hoc basis to variations in the value of one or more internal or external indices. For example, if someone needs a loan of £200,000 in order to purchase a particular property, he might arrange for the computer system of the preferred embodiment to set up a mortgage in which the amount underwritten is £250,000. He would then draw down the £250,000 and repay £50,000 as an offset linked to one or more of the internal funds defined by instances of the fund object F. The linked sum would then increase or decrease in value according to the variation in the indices to which the internal funds are linked. Increase in the value of the internally linked funds, as an offset, reduces the amount outstanding under the mortgage and, conversely, decrease in the value of the internally linked funds increases the amount outstanding under the mortgage.

By way of further example, if a mortgagee makes a regular monthly payment, for example £1000, the system according to the preferred embodiment of the invention may be set up so that the first £500 of any remainder after paying off interest will be linked to one or more of the internal funds and any remainder after that will be used for paying off capital.

If the sum which is linked to internal funds increases due to increase in the values of those funds, the mortgagee may require that the enhanced linked sum be used to pay off part or all of the remaining outstanding capital, thereby to pay off the mortgage earlier than would otherwise have been possible.

Further, internal transactions may be required in order to redistribute the sums linked to the internal funds, or to pay them out to the mortgagee, for example when there is a perceived risk that one or more of any external indices to which the internal funds are linked is likely to decrease significantly in value.

It follows that mortgages managed by the system may require, during their lives (which may be 20 years or more), the performance of large numbers of internal transactions involving the internal funds and their varying values.

For the system 12 to be practical, it must in general be capable of managing at least tens of thousands of mortgages. As a result the total number of internal transactions which have to be performed involving the internal funds and their values will be vast. Further, the value of any external indices to which the internal funds are linked is likely to vary greatly with time, and in the case of many external indices, will be constantly varying so that the value of the sum linked to one or more of the internal funds will constantly be out of date. In many cases the value of the sums linked will be out of date within minutes or hours of the link having been established. As a consequence, there are potentially significant data processing problems in the management and performance of such a vast number of internal transactions and in keeping track of the value of the sums linked to the internal funds.

In this embodiment of the invention, these problems are substantially avoided, in a manner which will be fully understood from later description, by converting the linked sums into internal fund units which have a unit price and performing the internal transactions, and storing the results, in terms of the number of fund units involved rather than in terms of the monetary sums involved at the time of the transaction. An internal fund unit price is therefore stored in the system for each instance of the fund object F and this price is arranged to vary in accordance with the external index to which the internal fund is linked. In the case of internal funds linked to external indices involving units, such as shares, the internal units may correspond one-to-one to the units (e.g. shares) of the external index and the internal fund unit price which is stored may be equal to the external unit value e.g. the external price per share.

It is, however, not necessary that the internal units should correspond on a one-to-one basis to external units nor that the stored internal fund unit price should equal the price of the external units. Some other relationship between the internal unit price and the external unit price could be used if more convenient in certain circumstances or if desirable to meet particular requirements for a particular mortgage arrangement.

In the present embodiment, the current internal fund unit price is not stored in the fund index object F. Instead, these values are stored in respective instances FP1 to FPm of a fund price object FP, which are thus linked to the appropriate respective instances of the fund index object F. Preferably, where possible, the internal fund unit prices stored in the different instances of the fund price object FP are updated at appropriate times automatically by providing a program in the server computer 2 which gathers the relevant data from appropriate websites accessed via the internet access terminal 8. Alternatively, or in addition, provision for manually setting and varying the values stored in one or more of the instances of the fund price object may be provided.

Interest Rate Object

The interest rates applied to different underwritings may differ from each other and the interest rates which apply to a given underwriting may change at certain times. For example, there may be a requirement for a reduction in interest rate after a defined period, for example three or four years.

To enable different interest rates to be applied, as required, to individual borrowings and managed efficiently, an interest rate object IR is provided. The different instances of the interest rate object IR define different interest rates and are used in interest rate calculations which are performed by the system. Thus, as will be described more fully later, when an interest rate calculation is to be performed in relation to a given underwriting, the execution of the transaction is controlled utilising one or more of the transaction control objects in the component 20 which causes the appropriate instance of the interest rate object IR to be accessed.

### OVERVIEW OF THE TRANSACTION CONTROL OBJECTS

The transaction control component 20 of the program 12 comprises eight objects as shown in FIG. 4. These objects store control data for controlling the data processing operations which are used for executing transactions in relation to the mortgages managed by the system. Different ones of these objects control respective different data processing operations or respective different parts of data processing operations.

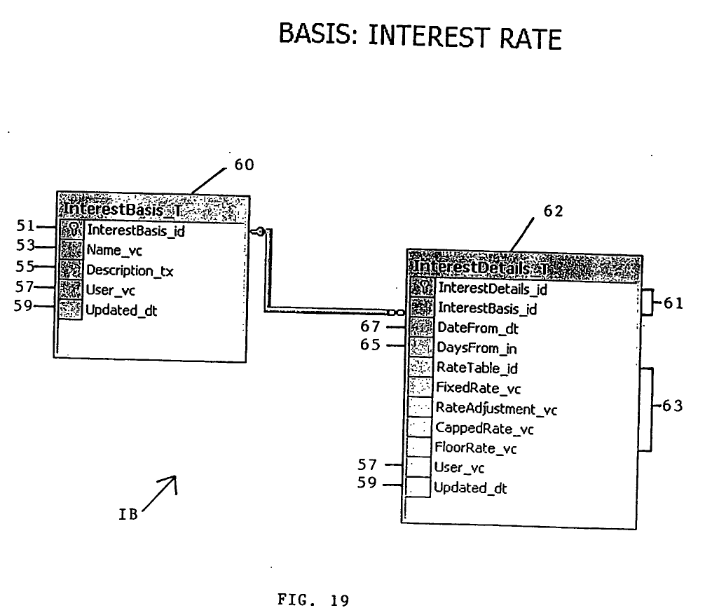

The control data stored in different instances of each of these objects may have different user selected and/or predefined values. As will be more fully explained later, with reference to FIGS. 19 to 26, the control data stored comprises transaction control data, whose values determine the manner in which transactions utilising that data are performed, and time control data whose values determine the time period or periods in which the transaction control data will be applied. Each instance of each transaction control object may store a number of sets of values of the transaction control data and a corresponding number of sets of values of the time control data so that the values of the transaction control data applied from a given instance of each transaction control object can be different at different times, as determined by the time control data.

Different instances U1 to Un of the underwriting object U and different instances P1 to Pn of the product object P can be linked to different instances of the objects of the control component 20 so that given types of transaction can be performed in different ways on different instances of the underwriting object U. The linkages between the different instances of the transaction control objects of component 20 and the different instances of the underwriting and product objects, together with the values of the stored control data, thereby determine the way in which different mortgages will be handled i.e. define the different mortgage “products” or arrangements. A conceptual example of such linkages will be described with reference to FIG. 5, after an outline description has been given of each of the transaction control objects of component 20.

Interest and Penalty Interest Basis Objects

Different instances IB1 to IBn of interest basis object IB and different instances PI1 to PIn of penalty interest basis object PI determine, by linkage to appropriate instances of the interest rate object, the interest rate to be applied during interest rate calculations on different instances of the underwriting object U.

Payment Target and Fund Investment Basis Objects

Payment target object PT defines the manner in which regularly scheduled payments are to be distributed between outstanding capital, outstanding interest, outstanding penalty interest and internal funds defined by the fund object F. The payment target object PT has provision for storing transaction control data defining this distribution by percentages and/or monetary amounts and for specifying the priority to be given to the different items to which the percentages and/or monetary amounts are to be applied.

Different instances PT1 to PTn of payment target object PT are set up with different values of the transaction control data so that respective different ones thereof cause respective different payment distributions. For example, one instance of the payment target object PT might be set up to apply the first part of each monthly payment in to paying off interest and any remainder to be applied 50% to paying off capital and 50% to be linked to an internal fund or funds. A different instance of payment target object PT might apply any such remainder in a different way, for example 25% to an internal fund or funds and 75% to the repayment of capital. A further instance might apply the first £200 of any remainder, after payment of interest, to an internal fund of funds and any remainder after that could be used for paying off part of the outstanding capital.

The payment target object PT does not itself identify the individual internal funds to which payments are to be applied, but merely the total amount or percentage which is to be applied to internal funds.

The identity or identities of the internal fund or funds to which any such payment is to be applied are defined by control data stored in the fund investment basis object FI. If a given mortgage arrangement involves allocation of payments to a single fund, this fund will be identified by an appropriate instance FI1 to FIn of the fund investment object FI. If a given mortgage involves allocation of payments to more than one internal fund, the identity of the funds and the manner in which the payment is to be distributed amongst the different funds will be defined by an appropriate instance of the fund investment object FI.

Where transactions are performed in which sums of money are applied to internal funds, these sums will be converted, at the time of the transaction, to fund units. These conversions are performed utilising the current fund unit prices stored in the appropriate instances of the fund price object at the time of the transaction. As will be more fully understood from subsequent description, this conversion facilitates the data processing operations employed in such transactions.

Thus, by setting up appropriate instances of the payment target object PT and the fund investment basis object FI, and linking these to different instances of the underwriting object U and/or of the product object P, an almost unlimited range of different offset type mortgage arrangements can be created and managed by the application program 12, subject only to adequate memory capacity and power of the server computer 2.

Auto Switch Basis Object

As will be understood from the foregoing, the system of the invention is capable of managing complex offset-type mortgage arrangements in which the values of stored internal fund units, which can be offset against the outstanding liabilities (in particular outstanding capital and interest), are exposed to internal or external variables or indices, such as the price of shares in a particular company or the FT-SE 100 index. There is consequently the risk that the value of the internal fund units associated with any given mortgage may change to an undesirable level compared to the liabilities associated with that mortgage.

To avoid this situation arising, the program 12 is arranged automatically to perform data processing operations at prescribed intervals in relation to individual underwritings (i.e. in relation to individual instances of the underwriting object U) in which the total value of the internal fund units (assets) associated with that underwriting and the liabilities (outstanding capital and outstanding interest) are calculated and changes in the assets are made, for example by switching units from one internal fund to another or by reducing the number of units with a corresponding reduction in liabilities, when necessary to prevent the value of the assets changing to a predetermined level in relation to the liabilities.

These data processing operations are controlled by auto switch basis object AS, different instances of which AS1 to ASn store different values of control data to define different conditions which will trigger a change and to define the change which will consequently take place. Individual instances of the underwriting object U are thus linked to appropriate instances of the auto switch basis object AS so that the triggering and nature of the changes performed automatically can be individually tailored to different mortgages.

Payment Review Basis Object

In general, it is desirable to determine whether the regular payments made by the mortgagee are sufficient to ensure that the loan will be paid off within the period intended. Since, as already described, complex offset-type mortgages may be set up and managed by the preferred embodiment of the invention in which internal fund values vary in accordance with external index values, it is possible for a situation to develop in which the current regular payment may be considered to have become insufficient or excessive.

In order to provide a warning that such a situation may be developing or has developed, the preferred embodiment of the invention is provided with facilities for reviewing, in relation to such mortgages, the asset and liability position having regard to the current and possible future internal fund value employed in the mortgage. The review will be performed to determine whether the regular payment amount is or is not sufficient, on the basis of the review, to produce the required future fund value.

Payment review basis object PR is provided for controlling such payment review processes. Individual instances PR1 to PRn of the review basis object PR are created and each instance stores control data whose values control the review processes to be used in relation to each instance of the underwriting object U and/or product object P.

Allocation Basis Object

Allocation basis object AB is provided for general allocation purposes, such as the allocation of bonuses or deductions for expense charges.

Thus, where an underwriting or product is to utilise the allocation basis object AB, different instances of the underwriting object U or product object P will be linked appropriate instances AB1 to ABn of the allocation basis object AB, which will define the relevant criteria for the allocation.

Redemption Penalty Basis Object

From time to time mortgagees may wish to redeem their mortgages before they are completed, in which case there are sometimes redemption penalties.

Redemption penalty basis object RP is provided for controlling the redemption penalty computation process, so that appropriate criteria may be applied in the redemption penalty process according to the time at which the mortgage is redeemed, in particular the remaining period of the mortgage.

Thus, different instances RP1 to RPn of the object RP are created, each storing control data whose values determine the criteria which are to be applied. Each instance of the underwriting object U and/or the product object P may thus be linked to an appropriate instance of the redemption penalty basis object RP so that the required redemption criteria are applied to each individual mortgage if it is redeemed.

### Overview of Linkages Between Mortgage Definition and Transaction Control Objects

From the above description of the mortgage definition objects contained in component 18 and the transaction control objects contained in component 20 of the application program 12, it can be appreciated that a given mortgage arrangement is defined by the linkages between the different instances of the underwriting object U or product object P and instances of the transaction control objects of component 20 and by the values of the time control data and transaction control data stored therein.

Each instance of the underwriting object U and the product object P can be linked to one instance of each of the eight transaction control objects which constitute component 20. A conceptual illustration of the linkages is shown in FIG. 5.

With reference to FIG. 5, an instance M20 of the mortgage object M is linked by pointers to an instance PD15 of the personal data object PD and an instance AD72 of the address data object AD (the numbers which represent the instances of the objects in the description of FIG. 5 are randomly selected for the purpose of illustration). Instance M20 thus defines the person whose details are contained in instance PD15 as the mortgagee of the property identified at instance AD72.

Instance U94 of underwriting object U is linked on the one hand to instance M20 and on the other hand to instance P57 of product object P, which in turn is linked to one instance of each of the objects contained in component 20.

Thus, instance P57 is linked to an instance IB9 of the interest basis object IB. It is assumed in this example that the interest rate applied is to be changed after certain period. The instance IB9 is therefore shown as linked to two instances IR1 and IR4 of the interest rate basis object IR. The time control data stored in instance IB9 will apply the interest rate in one of the instances (e.g. IR1) of the interest rate object in a first time period, say the first five years of the mortgage, and the interest rate in the other instance (e.g. IR4) thereafter, for example for the remainder of the period of the mortgage.

The interest basis object IB has provision for applying fixed interest rates. In this embodiment, the fixed rate of interest is stored in the relevant instance of the object IB, in which case there would be no link to the interest rate object IR in respect of fixed interest rates. Where fixed interest rates are to be applied for a certain period during the mortgage, that period would be defined by the time control data in the instance of the object IB. As will be understood from subsequent detailed description, using appropriate time control data it is possible to apply different fixed interest rates in different time periods.

Penalty interest is controlled in a similar way. Thus, instance P57 is shown linked an instance PI5 of the penalty interest basis object PI. Since instance PI5 is not shown in FIG. 5 as linked to any instances of the interest rate object IR, it is assumed that the penalty interest rate is fixed. It will be understood, however, from the above description of the interest basis object IB that different fixed rates can be applied at different times during the mortgage utilising appropriate time control data in the appropriate instance of the penalty interest object PI.

The manner in which incoming payments are to be distributed as between interest, penalty interest, capital and internal funds in the product defined by instance P57 of the product object P is determined by the values of the time control data and transaction control data stored in instance PT17 of the payment target object PT, to which instance P57 is linked. Utilising this data, the distribution which is applied may be different in periods of the mortgage, for example successive five-year periods of a 20 year mortgage.

For example, it may be that in the first five years no part of the payment should be allocated to payment of capital but instead the balance of any payment after any penalty interest and interest has been paid off should be applied in full to internal funds. In the next five-year period, such balance might be split 50-50 between internal funds and capital. In the third five-year period, 75% of such balance might be applied to capital and 25% to internal funds and in the final five years the whole of such balance might be applied to capital. The way in which the distribution is defined will be described more fully later.

As already noted above, the payment target object PT does not identify the specific internal fund or funds to which any payments linked to internal funds should be applied. That is the function of the fund investment basis object FI.

Thus, FIG. 5 shows instance P57 of the product object P linked (in this example) to instance FI24 of the fund investment basis object FI. The transaction control data therein defines the specific internal fund or funds to which payments should be linked. Where payments are to be split between a number of funds, the distribution may be defined by percentage and/or monetary value. Also, the order of priority to the given to those funds may be defined. Utilising appropriate values of the time control data, different distribution arrangements can be applied in different time periods.

In a similar manner, the instance P57 of the product object P is linked to individual instances AS19, PR4, AB2, and RP3 respectively of the auto switch basis object AS, the payment review basis object PR, the allocation basis object AB and the redemption penalty basis object RP. Each instance of these transaction control objects stores both transaction control data whose values control the manner in which transactions involving these objects are conducted and time control data enabling different values of the transaction control data to be applied in different time periods.

Although FIG. 5 shows linkages from an instance of the product object to the transaction control objects, mortgages can also be defined in this embodiment by linkages directly from an instance of the underwriting object to the transaction control objects if, for example, a particular bespoke arrangement is required, as has already been mentioned. It is considered unnecessary to illustrate such linkages as they will be apparent having considered the linkages shown in FIG. 5 between an instance of the product object and instances of the transaction control objects.

From consideration of the above description of FIG. 5, it can be appreciated that the variety of different mortgage arrangements which can be defined is virtually infinite. This facility is distinct from prior art systems for handling offset mortgages which merely permit the offsetting of a savings accounts against the capital account of a mortgage together with an offsetting of interest earned on the savings account against interest due on the mortgage account. The system of the preferred embodiment of the invention accordingly differs significantly in its power and flexibility and in particular in its ability to set up and manage complex offset-type mortgages in which the asset side is no longer limited to simple savings accounts but can employ any of a virtually unlimited number of internal funds whose values can be exposed to variations in external indices and can be offset against the capital and/or interest owing on the mortgage.

### EXECUTION OF TRANSACTIONS

The manner in which different transactions are executed in relation to different underwritings is described with reference to FIGS. 6, 7 and 8.

With reference to FIG. 6, component 22 comprises a group of objects which cause execution of the data processing operations, referred to as “pipeline processes” in this specification, required in operation of the system. Pipeline object PL shown in FIG. 6 is provided for identifying the numerous pipeline processes which the system may perform.

These processes are initiated either in response to preset schedules or ad hoc instructions. The preset schedules are defined by schedule object SCH and schedule pipeline object SP. Ad-hoc instructions are input from the client computers 4 and defined using ad hoc transaction object AT, adjustment object AO and auto pipeline object APO.

The most important of these data processing operations, so far as the invention is concerned, execute and record financial transactions in relation to the mortgages defined in component 18 and are controlled by the control data stored in the objects included in component 20.

Component 24 comprises computer executable code for performing the data processing operations which are necessary in relation to the mortgages defined in component 18. This code comprises a multiplicity of segments each defining a specific task. These segments of code are represented in FIG. 7 as task 1 to task n.

A given data processing operation, for example for processing regular payments in relation to the mortgages, may require a number of tasks for its completion. Other processing operations may require a single task. Different instances of pipeline object PL identify different data processing operations which may be performed. The task or combination of tasks required for the performance of respective different data processing operations is called by component 22 as required.

Those tasks which execute and record financial transactions are written so as to require control data from component 20. Some of these tasks execute and record a single financial transaction and others execute and record a number of financial transactions.

When tasks involving execution and recording of financial transactions are performed in relation to a given underwriting defined in component 18, the tasks obtain the required control data from the relevant instances of the objects in component 20 utilising identification data stored in component 22. In the case of scheduled transactions, this identification data is pre-stored in schedule pipeline object SP. In the case of ad hoc transactions, the identification data is inserted into ad hoc transaction object AT or adjustment object AO (as the case may be) when the ad hoc transaction or adjustment is instructed by a user of the system via the appropriate user interface.

Component 22 thereby executes financial transactions in relation to different mortgages defined in component 18 in different ways under control of the control data stored in component 20.

Execution of Pipeline Processes

When a financial transaction is to be executed, the function of the component 22 is:
1. To call, in the required order, the tasks required for execution of the pipeline process utilised in the transaction; and
2. To provide the identity of the relevant instance of the underwriting object so that the tasks obtain the control data appropriate to that underwriting.

The performance of each pipeline process requires initially the generation of an instance J1 to Jn of job queue object J. The manner in which these instances are created will be described later. At this point, it is only necessary to understand that every instance of the job queue object J relates to a specific job to be performed utilising a pipeline process. Each instance of the job queue object J accordingly contains:
1. The identity of the pipeline process to be used i.e. the identity of the instance of the pipeline object PL which defines the relevant pipeline process.
2. Data identifying (directly or indirectly in a manner to be described later) the instance of the underwriting or other object in relation to which the process is to be performed.

After each job has been completed, the instance of the job queue object J which related to it is discarded and the next instance of the job queue object J is accessed and the pipeline process identified in it is executed.

The sequence of tasks to be employed in each different pipeline process is identified by the pipeline connector link object PCL, connector object CON and task object TA shown in FIG. 6. Linkages between different instances of these objects are predefined in order to pre-define, for each respective different instance of the pipeline object PL, which ones of the tasks 1 to n are to be used in the pipeline process in question and the order in which these tasks are to be called. FIG. 7 includes a conceptual illustration of an example of these linkages, in which it is assumed that the pipeline process involved requires the execution of three tasks, namely task 3, task 6 and task 8.

As shown in FIG. 7, an instance J15 of the job queue object J is linked by the identity of the pipeline process which it contains to three instances PCL5, PCL6 and PCL8 of the pipeline connector link object PCL. It may be noted that the pipeline object PL is not employed at this point. This is because each instance of the pipeline connector link object PCL stores the identity of the pipeline process to which it relates i.e. the identity of the instance of the pipeline object PL which defines that pipeline process. In this example, therefore, the pipeline process identified by the relevant instance of the pipeline object PL utilises the three instances PCL5, PCL6 and PCL7.

Each instance of the pipeline connector link object contains the identity of and is thereby linked to a specific instance of the connector object CON which in turn contains the identity of and is thereby linked to a specific instance of the task object TA. Thus, in FIG. 7, instances PCL5, PCL6, and PCL8 respectively store the identities of and are thereby linked to instances CON2, CON8 and CON10 of the connector object. These respectively contain the identities of and are thereby linked to instances TA3, TA6, and TA8 of the task object TA. Each instance of the task object uniquely relates to a respective one of tasks 1 to n and includes code to call the respective task.

When a transaction is executed, the tasks are called and executed in sequence and in the order required by the pipeline process. Each instance of the pipeline connector link object PCL contains a sequence number which determines the order in which the tasks will be executed. It is consequently the combination of instances of the pipeline connector link object and their sequence numbers which determine the tasks required by each pipeline process and the order in which they will be executed. A given task may be used in a large number of different pipeline processes. Consequently, a large number of different instances of the pipeline connector link object PCL may be linked to the same instance of the connector object CON. Each instance of the connector object CON, however, uniquely relates to a single instance of the task object TA.

Transactions are initiated by creating a new instance of the job queue object J and inserting it in the job queue. This takes place either in response to a schedule pre-defined by schedule object SCH and schedule pipeline object SP, or in response to user instructions entered into ad hoc transaction object AT or adjustment object AO via an appropriate user interface downloaded from component 14 to one of the client computers 4.

Scheduled Transactions

Examples of a scheduled transaction are:
1. The collection of monthly payments and the distribution of the amounts collected in the manner defined by the objects of components 18 and 20 as between capital, interest and funds.
2. The calculation of interest, for example on a daily, weekly or monthly basis as defined by the objects of components 18 and 22.
3. Payment review utilising the appropriate instance of the payment review basis object PR, performed in advance of every scheduled payment.
4. Computations followed when appropriate by transactions, utilising the appropriate instance of the auto switch basis object AS, to determine whether or not it is necessary to make changes in the fund units linked to an underwriting and, when appropriate, making changes in those holdings in the manner defined in the relevant instance of the auto switch basis object AS.

Every scheduled transaction is defined by its own unique instance SP1 to SPn of schedule pipeline object SP which contains fields for storing the identity of the pipeline process to be used for execution of the transaction and the identity of the instance of the underwriting object U to which it relates.

The schedule pipeline object SP does not define the frequency with which the transaction to which it relates is to be executed nor the dates upon which the transactions are to take place. Instead, it contains a field identifying an appropriate instance SCH1 to SCHn of schedule object SCH which includes fields for storing data defining the frequency with which the transaction is to be performed (for example daily, weekly or monthly) and the date when it is next to be performed, which date is updated every time the transaction is executed. Accordingly, each instance of the schedule pipeline object SP will be linked to a unique instance of the schedule object SCH.

It follows that when a new mortgage is set up, new instances of the schedule pipeline object SP and the schedule object SCH may be created in order to define the scheduled transactions which are to take place.

When the system is operating, the program 12 causes the computer repeatedly to cycle through all instances of the schedule pipeline object SP and, for each instance, to access the corresponding instance of schedule object SCH to determine, from the data contained therein, whether the time has come to execute the process defined in the instance of the schedule pipeline object SCH in question. If so, a new instance of the job queue object J is created containing the identity (obtained from the relevant instance of the schedule pipeline object) of the pipeline process to be executed and the identity of the instance of the object (for example the underwriting object U) in relation to which it is to be performed. The new instance of the job queue object J is placed in the job queue for execution when its turn comes.

Ad Hoc Transactions and Adjustments

As already indicated, ad hoc transactions are set up using appropriate user interfaces downloaded from component 14 of the program 12 to the client computers 4. A large number of different kinds of ad hoc transaction can be performed in relation to any underwriting, including the following:
1. Purchasing internal fund units by specifying the required number of units to be purchased or specifying the amount of money to be used in the purchase (which will then be converted to a number of units using the current unit price) in one or more of the internal funds. The cost of the purchase can be covered by:
   (a) increasing the amount of borrowed capital;
   (b) making a payment in, as by cheque or directly debiting a bank account;
   (c) selling fund units already held in a different fund, this transaction involving switching units from one fund to another; or
   (d) any combination of these methods.
2. Selling units held in one or more internal funds by specifying a number of units to be sold or the amount of money to be realised by the sale. The proceeds of the sale can be:
   (a) used to repay outstanding capital or interest;
   (b) paid out as cash;
   (c) used to purchase units in one or more other internal funds; or
   (d) for combinations of the above.
3. Switching fund units between different internal funds.
4. Making adjustments for example to correct a mistake.
5. Making payments to reduce and/or pay off outstanding capital and/or interest.

The transactions identified in subparagraphs 1 to 3 are performed utilising the ad hoc transaction basis object AT, of which a new instance AT1 to ATn is created for each of the ad hoc transactions. The adjustments referred to in subparagraph 4 are performed using the adjustment object AD and again a new instance AD1 to ADn is created for each adjustment. These instances identify (amongst other things to be described later) the instance of the underwriting object on which the transaction is to be performed and the type of pipeline process to be used but not the actual identity of the pipeline process itself.

Selection of the actual pipeline process used is made by selecting an instance APO1 to APOn of auto pipeline object APO. These different instances are predefined and each stores the identity of the instance of the underwriting or product object to which it relates and the identity of the pipeline process type to which it is applicable. Utilising this data, the instance APO1 to APOn appropriate to a given ad hoc transaction or adjustment (which as indicated above contains like data) can then be selected. Each instance of the auto pipeline object also stores the identity of the required instance of the pipeline object PL, thus identifying the actual pipeline process to be used.

Following selection of the appropriate instance of the auto pipeline object APO, the identity of the pipeline process to be used is obtained and placed in a new instance of the job queue object J along with the identity of the instance of the underwriting object upon which the transaction is to be performed. The job will then be executed in the manner previously described in relation to scheduled transactions.

Upon completion, all transactions are recorded in the transaction database which constitutes component 26 of the program 12.

### TRANSACTION DATABASE

FIG. 8 is a diagram showing the structure of the database 26 which stores data recording the results of transactions performed on the mortgages managed by the system.

For illustrative purposes, this database 26 is shown in FIG. 8 as a table and is in simplified form so as to show only the fields which are of most importance to the invention. In practice, a number of additional fields will be provided in the transaction database, as will be described later, but the fields shown in FIG. 8 have been selected to facilitate the explanation of the manner in which the structure and content of the database 26 reduces the computer overhead necessary for the performance of various transactions involving the management of mortgages employing this embodiment of the invention, and makes it possible to perform transactions which would be impossible or extremely difficult with prior art mortgage management systems.

The database 26 comprises a plurality of transaction records. In FIG. 8, these records each comprises a respective different line in the tabular illustration employed in FIG. 8.

The fields of column 28 headed “transaction ID” store data, indicated in FIG. 8 as transaction 1 to transaction N, identifying the transaction to which the record relates. In practice, this identification data will simply be a numerical value generated automatically by the computer.

The fields of column 30 store the identity of the instance of the underwriting object U in relation to which the respective transaction has been executed. Column 32 stores the effective date of the transaction including a time stamp (not shown).

The fields of column 33 are used for storing the total monetary value (“book value”) of units purchased or units sold in any transaction involving purchase or sale of units.

Column 34 stores the monetary amount of capital involved in the transaction in the case of transactions involving the repayment of capital in or the payment of capital out. The amount thus may be positive or negative. Borrowings are indicated by positive figures and capital repayments are indicated by negative figures as they reduce the outstanding borrowing.

Column 36 stores the amount of interest involved in the transaction in the case of transactions involving the payment of interest. This will be positive in the case of the transaction in which interest due is calculated and negative in the case of the transaction in which the interest is paid off.

Column 38 stores the amount of penalty interest involved in the transaction when the payment of penalty interest is involved. This figure can likewise be positive or negative.

In the case of transactions involving fund units, column 40 stores the identity of the relevant instance of the fund object F. Column 42 stores the number of fund units involved in the transaction and can accordingly be positive or negative. Column 44 stores a reference to the identity of the fund unit price which was used in converting money amounts to fund units or amounts of fund units to money, as the case may be when the transaction involves such calculations. For this purpose, the program 12 stores a complete history (not shown in the drawings) of the unit prices of the various funds, in addition to current unit price stored in the appropriate instance of the fund price object FP.

Column 46 stores the date up to which interest has been calculated.

In FIG. 8, various fields have been filled in with examples of data to facilitate an explanation some examples of transactions which have been performed, thereby to clarify the way in which the transaction database 26 is used. These are referred to as transactions 1 to 7 and transaction N. For simplicity, any difference between bid and offer prices is ignored.

Transactions 1 and 2

These two transactions are both part of the same processing operation, in which units in one fund are exchanged for units in another at zero cost. As shown in FIG. 8, these two transactions were both performed on the underwriting identified by instance U1794 of the underwriting object on 14 Jul. 2001.

In transaction 1, 10,000 units in the fund identified by instance F20 of the fund object were sold at the then applicable selling price for those units as identified in the relevant instance of the fund price object FP at the time of the transaction. It is assumed that the selling price was £0.08, realising £800 and that, in transaction 2, this £800 was used to purchase 1600 units in the fund F3 at a purchase price of £0.50 which was applicable on the date of the transaction.

The book value for each of transactions 1 and 2 was therefore £800.

Transaction 3

This was performed on the underwriting identified by instance U275 of the underwriting object on 15 Jul. 2001.

4000 units in fund F13 were sold at the selling price of £0.50, obtained from the relevant instance of the fund price object FP at the date of the transaction, realising £2000. This was used to pay off part of the outstanding capital and thus the figure of −£2000 appears in the “capital” field in column 34.

The book value was therefore £2000.

Transaction 4

This was performed on the underwriting defined by instance U9728 of the underwriting object U on 15 Jul. 2001.

As indicated by the figure of £5000 in column 34, an additional borrowing of £5000 was made. As shown by data in the relevant fields of columns 40, 42 and 44, this additional borrowing was used to purchase 2500 units in the fund defined by instance F19 of the fund object at a unit purchase price of £2.00. This is the purchase price which was obtained from the relevant instance of the fund price object FP at the date of the transaction. The book value was £5000.

Transactions 5 and 6

These two transactions form part of the same process in which an additional borrowing is made and used to purchase units in two different funds. The two transactions were performed on 15 Jul. 2001 in relation to the underwriting identified by instance U205 of the underwriting object.

An additional total borrowing of £2000 was made. As indicated by the two positive entries of £1000 in column 34 in relation to transactions 5 and 6 respectively, half of the borrowed amount was used to purchase 5000 units in the fund identified by instance F42 at a purchase price of £0.20 obtained, at the date of the transaction, from the instance of the fund price object linked to instance F42. The other half was used to purchase 200 units in the fund identified by instance F91 of the fund object at a purchase price of £5.00 obtained, again at the date of the transaction, from the relevant instance of the fund price object FP.

The book value of each transaction was £1000.

Transaction 7

This was performed on the underwriting identified by instance U1041 of the underwriting object on 15 Jul. 2001.

A payment in, which may have been part of a regular monthly payment controlled by an appropriate schedule and appropriate instances of the payment target object PT and the fund investment basis object FI, was made and distributed between capital, interest and units in the fund identified by instance F20 of the fund object.

Is assumed that the total payment in was £1000, which is therefore shown as the book value of the transaction in FIG. 8.

Examination of the fields of columns 34 of 36 relating to transaction 7 show that £500 was used to pay off capital and £300 was used to pay off interest. Both figures are therefore shown as negative. The remaining £200 was used to purchase 2000 units in fund F20 as shown by the entries in columns 40 and 42 for transaction 7. Accordingly, it can be understood that the unit purchase price would have been £0.10. This purchase price is the price for those units which was valid at the date of the transaction and was obtained from the relevant instance of the fund price object at that date.

Transaction N

Transaction N was performed on the underwriting identified by instance U4932 of the underwriting object on 25 Oct. 2001.

An ad hoc payment in of £6000 is assumed, which is shown as the book value in column 33. It is assumed that all of the £6000 was used to purchase units in fund F91 at a purchase price of £6.00 per unit, which was the applicable price on that day as obtained from the relevant instance of the fund price object FP.

As seen from the table, transaction 6 and transaction N both involved purchase of units in fund F91, but at different prices since it is assumed in the examples that the price for a unit increased from £5.00 to £6.00 in the period from 15 Jul. to 25 Oct. 2001.

It can thus be appreciated that the current value of the number of units held in a particular fund by a particular underwriting is obtainable by multiplying the number of units by the current price a unit stored in the relevant instance of the fund price object FP. Such current value is unlikely to be the same as the value of those units at the date of the transaction in which they were bought or sold.

When the current position, in relation to any mortgage involving funds and fund units, is required, the current liabilities and the current value of the assets are calculated from data stored in the transaction database 26. To calculate the current position the computer is caused to search the database for all transactions in relation to the relevant underwriting, this searching being conducted on those fields of the database represented in column 30 in FIG. 8.

The current liability position is obtained by
1. summing the positive and negative amounts of capital in the fields of column 34 relating to that underwriting;
2. summing the positive and negative amounts of interest accrued and interest paid in columns 36 and 38 to obtain a FIG. 4 the current interest due if any; and
3. adding together the figures obtained in steps 1 and 2.

The current asset position is calculated as follows:
(1) The total number of units currently held in a given fund in relation to the relevant underwriting is calculated by:
   (a) identifying from column 30 and column 40 those fields of column 42 which relate to the same underwriting and fund; and
   (b) summing the positive and negative figures in the fields of column 42 identified in step (a).
(2) The resulting total number of units in the fund to which step (1) relates is then multiplied by the current unit price for that fund, which is obtained from the relevant instance of the fund price object FP.
(3) Since steps (1) and (2) give the asset value relating to a single fund only, these steps are repeated for each fund to which the relevant instance of the underwriting is linked as indicated by the fund identities in the fields of column 40 relating to the relevant underwriting.
(4) The asset values relating to the respective different funds as calculated in steps (1), (2) and (3) are summed to give a total asset value i.e. the total current value of the units held in the funds to which the relevant instance of the underwriting object is linked.

In this way, the current asset and liability position can be quickly, easily and accurately calculated at any time, and the net outstanding liability of the mortgage can then be calculated by subtracting the current asset position from the current liability position as calculated above.

A factor contributing to this advantage is the storage, in database 26, of asset values as numbers of units which can easily be converted to current monetary values utilising the current unit price obtainable at any time from the instance of the fund price object FP to which the units relate. It is important to note that the fund price reference in column 44 for past transactions is not used during asset calculations, as those figures are a record of the fund price at the time of the past transaction and are almost inevitably not going to be equal to the current fund price.

Thus it is an easy and rapid task for the computer to find, for a given underwriting, those records in the transaction database 26 which relate to it (and the summary position of any archived transactions) and to calculate therefrom the current asset and liability position in the manner described above.

It will be noted from the above description of the transaction database 26 that, in this embodiment of the invention, a new record (i.e. a new line in the tabular illustration of FIG. 8) is added to the database for recording data in relation to each new transaction as each new transaction is completed. Thus, as the system is used over a long period of time, the transaction database will get bigger and bigger. When the mortgage system is used to manage a large number of mortgages over a long period of time, therefore, the number of transactions stored in the transaction database will be vast. Accordingly, if it is desired to limit the size of the database which has to be searched, older transactions may be archived and a summary (in relation to each underwriting) of the position at the date of the last archived transaction prepared and stored and this summary used as the starting point for calculations.

As a further alternative, it would be possible to store in association with each underwriting the current total number of units held in each fund by that underwriting. This would involve computing this total number each time a transaction takes place involving purchase or sale of fund units. These stored total numbers could then be used in calculations of the current asset position by multiplying the stored total numbers by the relevant current fund unit price. The full transaction database could then be archived and used only when required or particular reasons, such as for auditing purposes or for tracing the origin of any errors, or if desired it may be dispensed with.

### DETAILED EXAMPLES OF THE OBJECTS

The purpose and functionality of the components 14, 16, 18, 20, 22, 24 and 26 of the program 12, and of the numerous objects included in a number of those components, will be understood from the above general description.

A detailed description of examples of the objects will now be given with the assistance of FIGS. 9 to 33. This description will explain the data fields included in each object, the nature of the data to be inserted in those fields and the way in which that data is utilised to interlink the various objects and to control the various processing operations which take place.

This description will be followed by a description, with reference to FIGS. 34 to 46, of examples of user interfaces which may be used for entering data into the various objects, so that a variety of different mortgages can be set up in the system.

### NAME AND ADDRESS RECORD OBJECTS

Personal Data Object

FIG. 9 shows a detailed example of the personal data object PD. The legends in the various field locations of FIG. 9 indicate the nature of the data which they contain and hence it is not necessary to describe every field in detail.

It should be noted, however, that the field entitled PersonalData ID is for containing the data which identifies the different instances of this object. The three fields relating to address data are for containing the identification data for three different instances of the address data object. Hence there is provision for recording, for each person, a principal address utilising the field labelled Address ID and up to three other addresses utilising the fields labelled Address2 ID, Address3 ID and Address4 ID. It should be noted that none of these four addresses is necessarily the address of a mortgaged property.

The field labelled “user VC” is for identifying the administrator who has entered data into the object and/or created the instance of it. The field labelled “Owner ID” contains a generic reference to the instance of the object and is for computational purposes which are not relevant to the invention. Similarly labelled fields in some of the objects illustrated in subsequent drawings have the same significance.

Company Data Object

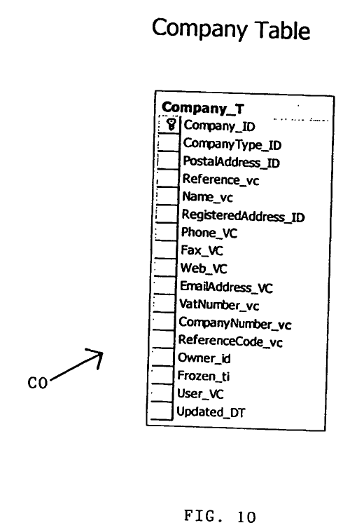

FIG. 10 shows a detailed example of the company data object CD. The top field shown is for containing data identifying the relevant instance of the object so that other objects may be linked to it. The data which the remaining fields are to contain will be evident from the legends in FIG. 10, therefore further description of FIG. 10 is unnecessary.

Address Data Object

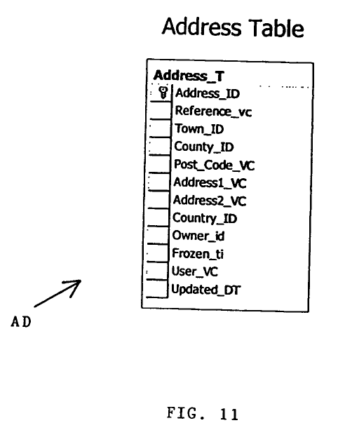

FIG. 11 shows a detailed example of the address data object and again the uppermost field shown in the drawing is for the identity of the relevant instance of the address data object. It is this field which is used to provide a link between an instance of the address data object AD and an instance of the personal data object PD by putting the identity of the instance of the address data object PD into one of the three address fields of the personal data object PD.

Bank Account Object

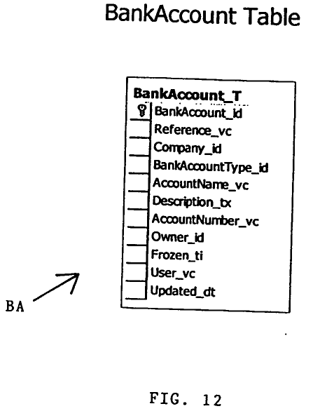

The nature of the data to be inserted in most of the fields of the bank account object BA will be evident from the legends in FIG. 12, which is a detailed example of this object. The field labelled “Company ID” is for linking to an instance of the company object CD for the identity of the bank at which the account is held. Further description is therefore not necessary.

### MORTGAGE DEFINITION OBJECTS

Mortgage Object

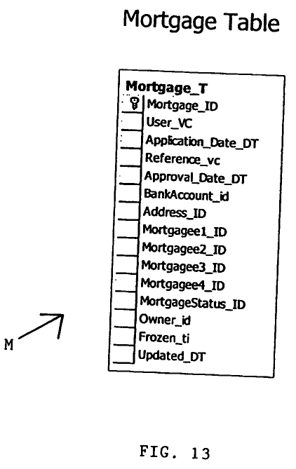

With reference to FIG. 13, the example of the mortgage object M shown has a field at the top labelled Mortgage ID for containing the identity of the relevant instance of this object, a field labelled Address ID for containing the identification data of the instance of the address data object AD which relates to the mortgaged property and four fields labelled Mortgagee1 ID, Mortgagee2 ID, Mortgagee3 ID and Mortgagee4 ID each for the identity of a respective different instance of the personal data object PD, thereby providing for the possibility of up to four mortgagees as parties to the same mortgage. The remaining fields in FIG. 13 will be self-explanatory.

Underwriting Object

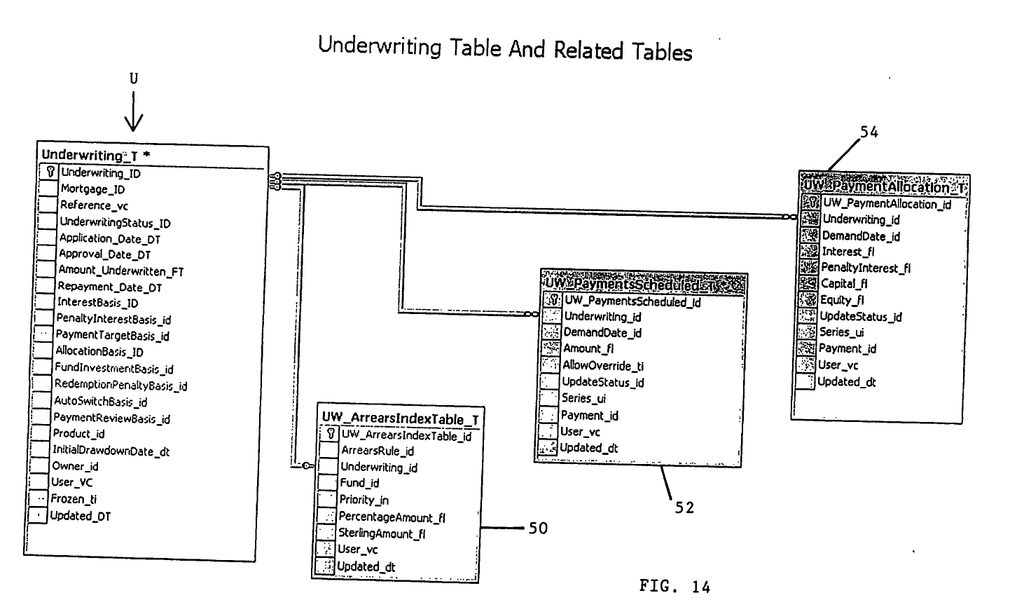

With reference to FIG. 14, the underwriting object U includes an uppermost field for the identity of the relevant instance of this object and a field labelled Mortgage ID for containing the identity of the instance of the mortgage object to which it relates. There are also, as shown, fields for the date when the loan was applied for (application date), when it was approved, the amount underwritten and the date by which repayment is due, as will be self-evident from the legends in underwriting object U as shown in FIG. 14.

There are also eight fields in the underwriting object U for containing identification data for linking the relevant instance of the underwriting object U to selected instances of the eight transaction control objects shown in FIG. 4. The relevant fields are labelled respectively InterestBasis ID, PenaltyInterest ID, PaymentTargetBasis ID, AllocationBasis ID, FundInvestmentBasis ID, RedemptionPenaltyBasis ID, AutoSwitchBasis ID and PaymentReviewBasis ID. From the legends, it will be self-evident which field is for linking to which of the transaction control objects of FIG. 4.

There is also a field labelled Product ID for linking to a selected instance of the product object P. As already indicated, when this field is used, any direct links to the transaction control objects of FIG. 4 are overridden.

FIG. 14 also shows three further tables linked to the underwriting object U.

Table 50 is for defining the way in which arrears will be handled. As can be seen, this contains a field labelled Underwriting ID which links it to the relevant instance of the underwriting object and a field labelled ArrearsRule ID for linking table 50 to an appropriate user defined rule for the handling of arrears. One way in which arrears might be handled is for the overdue payments to be funded by selling units in one or more of the internal funds to which the underwriting is linked. In such a case, the fields in table 50 labelled Fund ID, Priority, PercentageAmount and SterlingAmount are for identifying the fund from which units should be sold, the priority to be given to that fund and the percentage or monetary amount to be obtained respectively. If the arrears rule provides for the selling of units from more than one fund, a separate instance of table 50 is created for each fund.

Table 52 is for providing records relating to regular payments in. When an underwriting is first set up, an instance of table 52 is created and linked to the relevant instance of the underwriting object by the field labelled Underwriting ID. The amount of the intended regular payment in is entered into the field of table 52 labelled Amount FL. The date of the first regular payment is obtained from an instance of the schedule pipeline object SP whose pipeline process type is “regular payment”. If at some future date the amount of the regular payment in is to be changed, a new instance of the table 52 is created containing the new amount and the first date on which the new amount is used. Changes in the amount of the regular payment can be done manually at any time. Alternatively, by entering an appropriate flag in the field labelled AllowOverRide, the amount may be changed automatically in response to the payment review process which, as indicated earlier, is controlled by the payment review object PR.

The field labelled Series UI is for recording an identification number which has the same value in all instances of all objects used in any given transaction so that in future the instances of the objects used in a transaction can easily be found for auditing purposes. Similarly labelled fields are contained in a number of the tables to be described later. They have the same purpose and therefore and subsequent description of them will be unnecessary.

The field labelled Payment ID is for linking to the relevant record in a table (not shown) which contains a list of all payments and indicates the identity of the payer and the payee(s) in each case. In the case of a payment in, the instance of the relevant mortgage object will be identified as the payer and the relevant instance or instances of the underwriting object will be recorded as a payee(s).

Table 54 is used in the actual process of making a payment on the day that the payment is made. A new instance of this table is created in advance, typically a few days or a week in advance, of each date on which a payment is due. This new instance is created by a pipeline process which is executed in response to a preset schedule and which carries out a payment preparation process which determines the values to be entered into the new instance of table 54. The relevant values are the date on which the payment is to be made which is referenced by the field labelled DemandDate ID and the amounts respectively to be used to pay off interest, penalty interest and/or capital and the amount, if any, to be paid to equity i.e. linked to internal funds. The fields in which these values are entered will be evident from consideration of table 54. It should be noted that the value entered into the fields labelled equity is for the total amount to be linked to internal funds and does not indicate the way in which this is to be distributed between internal funds (that is the function of the fund investment basis object FI). The payment review pipeline process links the new instance of table 54 to the relevant instance of the underwriting object using the field labelled Underwriting ID.

Product Object

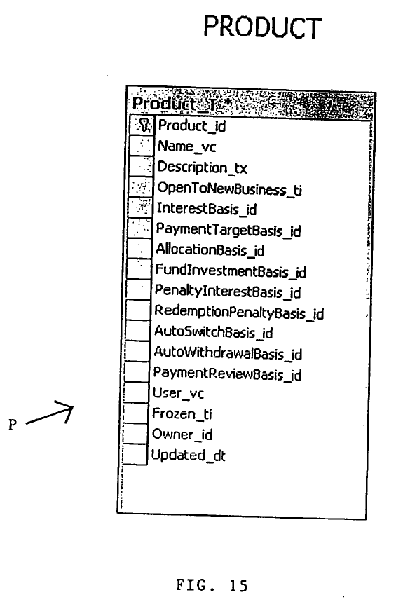

As shown in FIG. 15, the product object P has a field labelled Product ID for identifying each instance thereof. This is used for linkage to the correspondingly named field in the relevant instance of the underwriting object U. There is also field for the name of the product and another one for a description of it, as indicated by the legends in FIG. 15.

The product object also has eight fields respectively for linking to the appropriate instances of the eight transaction control objects of FIG. 4, these being labelled in the same way as the corresponding fields in the underwriting object U. As already indicated, numerous “products” can be set up in advance using the product object. This set up involves creating a new instance of the product object, setting up appropriate instances of the transaction control objects of FIG. 4 and inserting the required control data therein, and linking them to the new instance product object.

Setting up a new product also requires the definition of automated processes which may be performed in relation to the product. The way in which these processes are automated will be described later. The timing of their execution in certain cases will be defined by instances of the schedule pipeline object SP and schedule object SCH and in other cases they will be initiated in response to an ad hoc instruction.

Hence, it will be understood that each product includes both a definition of the automated pipeline processes which will be used, each as previously described comprising a sequence of tasks, and a definition, using the transaction control objects of component 20, of the values of the control data to be used when executing those tasks.

Fun Object

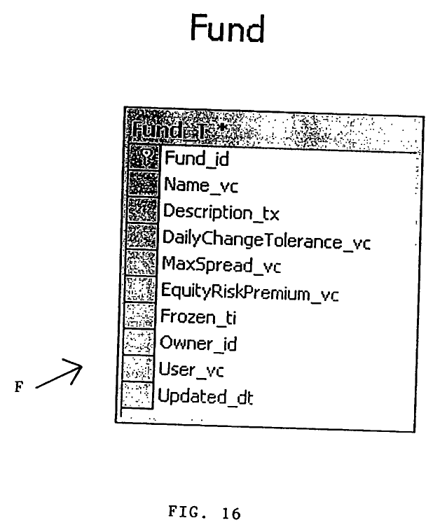

With reference to FIG. 16, the fund object F has fields for the fund ID to be used for linkages to instances of the fund investment basis object FI of FIG. 4. There are also fields for the name of the fund and a description of it. These will be self-evident from the drawing.

The field labelled DailyChangeTolerance is for specifying a limit, normally a percentage, on the permitted daily variation in the unit price of the fund. When the system is set up, processes can be created which will utilise this limit for checking purposes.

The field labelled MaxSpread is likewise for specifying a limit on the maximum permissible variation between the buying and selling prices and may be utilised in checking processes defined when the system is set up.

The field labelled EquityRiskPremium is for specifying percentage amount which may be used, together with data from the relevant instance of the payment review object PR, in a payment review process, which will be described more fully later, to determine the appropriate schedule of payments to be made sufficient to achieve a repayment objective.

Fund Price Object

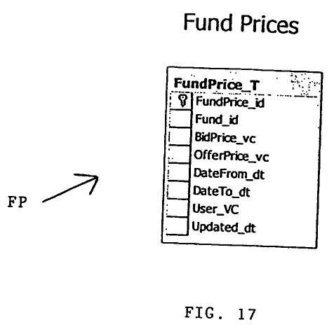

With reference to FIG. 17, the fund Price object FP has a field FundPrice ID for identification of each instance of this object and another field labelled Fund ID for linkage to the correspondingly named field of the instance of the fund object F to which it belongs. There are also fields for the unit purchase price (BidPrice), the unit selling price (Offerprice) and for the dates from and to which the instance and therefore the prices contained in it are or were applicable.

New instances of the fund price object are created at predefined intervals in response to a scheduled pipeline process, which may be executed for example hourly or daily, and the unit price current at the time of execution of this process is inserted into the new instance of the fund price object FP. The frequency at which this process is executed will be selected dependent upon the nature of the fund and the requirements of the mortgage. It will be appreciated, therefore, that where the fund unit price relates to an external value, it is possible to cause the internal unit price to follow closely rapid changes in the external value or merely to follow the values at relatively widely spaced intervals thereby filtering out short term variations.

Instead of setting up new instances in response to a predefined schedule, it would be possible to set up new instances with new unit prices in response to predefined magnitudes of change in the external index, or a combination of both time and magnitude change.

Also, the system includes provision for manually setting up new instances of the fund price object for defining unit price in future date ranges.

For the purpose of correcting errors which may have arisen in an instance of the fund price object which has been already used in one or more transactions, provision is included for manually changing the unit price in an existing instance and this provision includes the means for executing a pipeline process which will make corresponding corrections in the transactions which have used the incorrect unit price if required.

Interest Rate Object

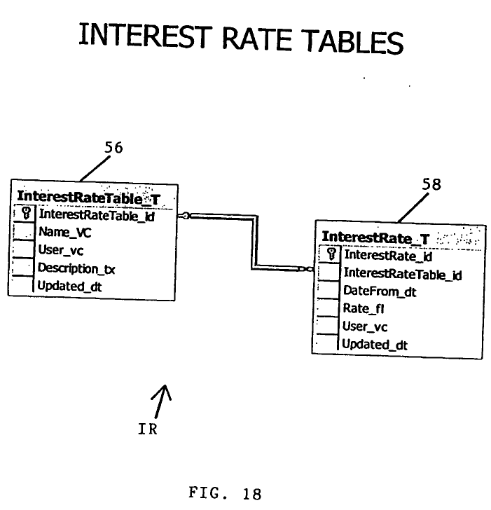

The interest rate object IR comprises two tables 56 and 58 as shown in FIG. 18.

The table 56 has a field for the name of the interest rate to which it relates and a field labelled InterestRateTable ID for linking to the correspondingly named field for the relevant instance of the table 58.

The latter table contains, in its field labelled Rate, the actual interest rate to be used. A further field labelled DateFrom contains the date from which the rate is applicable. When the interest rate changes, a new instance of the table 58 is created specifying the new rate and the date from which it is applicable.

### TRANSACTION CONTROL OBJECTS

Common Structural Features

As will be understood from the following description of FIGS. 19 to 26, each of the transaction control objects of component 20 comprises a primary table and one or more supplementary tables linked to the primary table. The different instances of the transaction control objects are identified by data stored in the primary table. The values of the control data relating to each instance are stored in the supplementary table or tables to which the instance of the primary table is linked.

Since each of the transaction control objects has a number of fields which have a similar purpose to corresponding fields in the other transaction control objects, these fields will be described first, before describing the individual objects, to avoid repetitive description. The fields which are in common in the objects will be identified by the same reference numbers in each of the objects illustrated in FIGS. 19 to 26. Further, the primary tables of the objects shown in FIGS. 19 to 26 are all identified by reference numeral 60 because all of the primary tables have a similar purpose and contain similar fields. The remaining tables shown in FIGS. 19 to 26 are the supplementary tables. Since these tables differ from each other, they are identified by their own individual reference numbers and will be described individually after the common features of FIGS. 19 to 26 have been described.

Each primary table 60 of each transaction control object comprises five fields identified in each of FIGS. 19 to 26 by the reference numbers 51, 53, 55, 57 and 59.

The field 51 is for storing code identifying the instance of the object in question. This identification code is used on the one hand for linking to instances of the underwriting and/or product objects and, on the other hand, for linking to the relevant supplementary table or tables of the instance of the object.

Each field 53 is used for storing a name for the instance. For example, the different instances of the interest basis object IB might be called Interest Basis 1, Interest Basis 2 etc. and different instances of the payment target object might be called Payment Target 1, Payment Target 2 etc.

Each field 55 is for storing text, particularly for storing a description of the instance in question.

The fields 57 and 59 are respectively for storing the identity of the user who created or last updated the table and the date of the last update. The supplementary tables also each include two fields for this purpose, and these are likewise identified by reference numbers 57 and 59.

The supplementary tables contain fields 61 for identification data, both for providing an identity to each respective instance of the supplementary table and for linking the supplementary table to the primary table and/or other supplementary tables in those transaction control objects having more than one supplementary table. The remaining fields 63, 65 and 67 provided in the supplementary tables are for storing the control data which is used in relation to the performance of transactions.

The fields 63, as previously described, will cause transactions to be performed in different ways in dependence upon the values stored in these fields. The number of fields 63 provided, and the nature of the control data, depends upon the purpose of the respective transaction control object. These fields, in the different transaction control objects, will be separately described in relation to each of FIGS. 19 to 26.

The fields 65, which are labelled DaysFrom in the relevant supplementary fields of all of the transaction control objects shown in FIGS. 19 to 26, are for specifying the number of days which must elapse before the control data in the relevant instance of the supplementary table is applied to transactions. The relevant tasks of component 24 are arranged to count the number of days stored in the field 65 from the date stored in the InitialDrawDownDate field of the instance of the underwriting object U to which the instance of the transaction control object is linked.

It follows that if the control data is to be applied immediately following the initial draw down date, the value stored in the field 65 of the relevant instance of the supplementary table will be 0. If one month is to elapse the stored number would be 30 and if a year is to elapse, the number stored in field 65 will be 365. The processing tasks of component 24 will be written (if required) to interpret the numbers in the fields 65 in a manner which takes into account leap years and the fact that different months have different numbers of days. Thus, for example, the number 30 could be interpreted by the tasks as meaning one calendar month.

The program 12 is arranged so that, within each instance of each transaction control object, different instances of the supplementary table or tables may be created, each containing different values for the control data in the fields 63, and each containing a different number in the DaysFrom field 65. In this way, the values of the control data in the field 63 in respective different instances of the supplementary tables can be brought into effect after the lapsing of different time periods from the first draw down date of the underwriting to which the instance of the transaction control object is linked.

To achieve this, the processing tasks of component 24 will accordingly be written so that the control data stored in the fields 63 of a given instance of a supplementary table in a given instance of a transaction control object will be utilised for that period of time which:
(a) begins at the end of the elapsed time specified in the DaysFrom field which governs it; and
(b) ends at the end of the next longer elapsed time (if any) specified in the DaysFrom field governing another instance of the supplementary table forming part of the same instance of the relevant transaction control object.

As one example of the use of this facility, the interest rate defined by the a particular instance of the interest rate basis object IB linked to a particular instance of the underwriting object U can automatically change after a selected period or periods. As another example, the distribution of incoming payments as between interest, capital and fund units, as defined by a particular instance of the payment target object PT and a particular instance of fund investment basis object FI linked to a particular instance of the underwriting object U, can automatically change after specified periods. The length of the elapsed time specified can be anything from 0 (i.e. the values of control data are applied immediately) to a few days, a few weeks, a few months or a number of years.

The DateFrom field 67 has a completely different purpose from the DaysFrom field 65.

The DateFrom field 67 is for recording the beginning of the period for which the instance will be valid. Any mortgage which comes into effect having an initial draw down date on or after the date specified in the DateFrom field and which is linked to the relevant instance of the transaction control object will be controlled by the values of the control data in the fields 63 and 65 of that instance.

If the use of an instance of one or more of the supplementary tables is to be discontinued in relation to any underwriting which comes into effect after a future date, a new instance of the appropriate supplementary table is created with the appropriate future date inserted in the DateFrom field 67 and the required values of the control data are inserted in the fields 63 and 65 as described above. Any new underwriting in which the date in its InitialDrawDownDate field is on or after the date specified in the DateFrom field of the new instance of the supplementary table will then be controlled by that new instance.

Old mortgages i.e. those having an initial draw down date before the DateFrom date of the new instance of the supplementary table will continue to be controlled by the old instance thereof.

The processing tasks of component 24 will accordingly be written to interpret the data in the DateFrom fields 67 in this way. As an alternative, however, they could be written so as to relate the date in the DateFrom field 67 to some data other than the InitialDrawDownDate, such as the date on which a mortgage is applied for or the date on which it is approved, as stored respectively in the fields labelled Application_Date and Approval_Date in the underwriting object U.

Interest Basis Object

As shown in FIG. 19, the field 51 of the primary table 60 of the interest basis object IB is labelled InterestBasis ID and is for linking to correspondingly named fields, on the one hand, in an instance of the underwriting object or product object and, on the other hand, to a supplementary table 62.

The fields 63 of the supplementary table 62 are as follows:
1. A field labelled RateTable is for containing the identity of an instance of interest rate table 58 and this corresponds to the InterestRate ID field of table 58.
2. A field labelled RateAdjustment is for applying an adjustment to the interest rate specified in the instance of table 58 to which table 62 is linked.
3. Fields labelled CappedRate and FloorRate are for placing upper and lower limits on the amount of interest that can be charged.
4. A field labelled FixedRate is for inserting a fixed interest rate, in which case the fields labelled RateTable, RateAdjustment, CappedRate and FloorRate would be left blank.

As already explained, different instances of the table 62 containing different values for the data in one or more of the fields 63, 65 and 67, may be created as required for the purposes explained above.

Different instances of the primary table 60, linked to an appropriate instance or instances of the supplementary table 62, may be created and linked to different instances of the underwriting and/or product object so that transactions involving interest on different underwriting is all different products may be controlled differently.

Penalty Interest Object

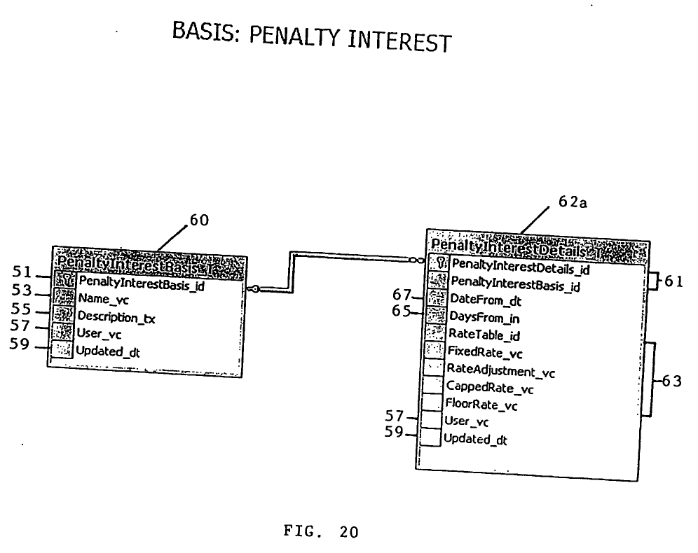

As shown in FIG. 20, the penalty interest object PI comprises, as shown in FIG. 20, a primary table 60 and the supplementary table 62a. These correspond to the tables 60 and 62 of FIG. 20 and have the same fields for the same purpose, apart from references to penalty interest as distinct to references to interest.

FIG. 20 need not be described any further.

Payment Target Object

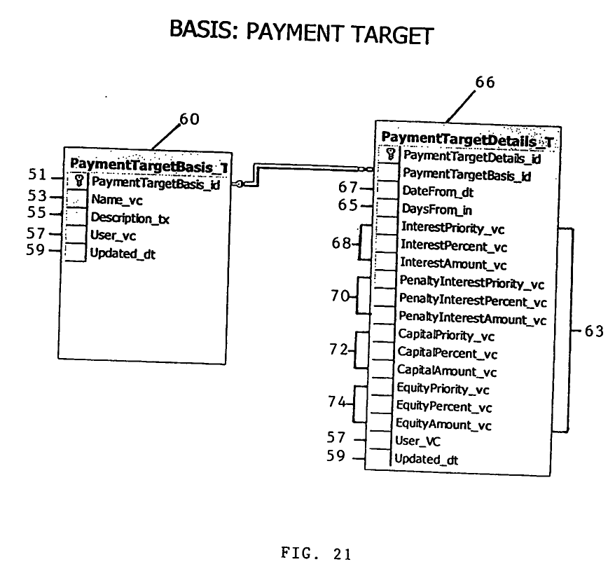

With reference to FIG. 21, the payment target object PT comprises a primary table 60 and the supplementary table 66.

Field 51 of the primary table 60 is labelled PaymentTargetBasis ID for linking to the corresponding fields in the underwriting or product object and the supplementary table 66.

The field 63 of the table 66 are in four groups containing three fields each, namely group 68 which relates to payment of interest, group 70 which relates to payment of penalty interest, group 72 which relates to payment of capital and group 74 which relates to equity or investments in the internal funds. These groups of fields are for specifying the way in which payments should be distributed amongst these four items.

The first field of each of groups 68, 70, 72 and 74 is for specifying the priority to be given to the item in question, the second field of each group is for specifying the percentage of the payment which should be used and the third field of each group is for specifying the amount of the payment which should be used. The percentage and amount fields are therefore used alternatively to each other.

Thus, using these twelve fields, it is possible to divide incoming payments as between interest, penalty interest, capital and equity (funds) in any priority and either on the basis of percentages or amounts.

Thus it will be seen that the values inserted in these twelve tables control the way in which payments are distributed when transactions are executed.

The remaining fields of tables 60 and 66 have already been explained above and require no further description. From the above description it will be appreciated that different instances of the supplementary table 66 can be created, and linked to the same instance of the primary table 60 of the payment target object PT, with different values for the control data in one or more of the fields 63 and the fields 65 and/or 67 for the reasons explained.

Fund Investment Basis Object

The fund investment basis object FI comprises three a primary table 60 and two supplementary tables 78 and 80.

The field 51 of the table 60 is labelled FundInvestmentBasis and is for linking, on the one hand, to an instance of the underwriting object or product object and on the other hand to one or more instances of the supplementary table 78.

Table 78 contains the DateFrom and DaysFrom fields 65 and 67 for the purposes previously explained. Different instances of the table 78 may therefore be created with different values in these fields.

Each instance of the supplementary tables 78 may be linked to one or more instances of the table 80 by the fields labelled FundInvestmentDetails ID present in both the table 78 and the table 80.

Table 80 is for specifying the identity of the fund to which payments are to be directed. A separate instance of table 80 is created for each fund to which payments are to be linked. There may thus be several instances of table 80 linked to each instance of table 78 and several instances of table 78 linked to each instance of table 60 of this object. Each of those instances of table 80 will specify the priority that is to be given to the fund identified in the fund ID field thereof and the amount to be directed to that fund by percentage or monetary value, using the PercentageAmount or SterlingAmount field as appropriate.

The values of the data in the DaysFrom and DateFrom fields 65 and 67 in the table 78 will control the application of the values in the instances of the table 80 to which it is linked, in the manner previously described.

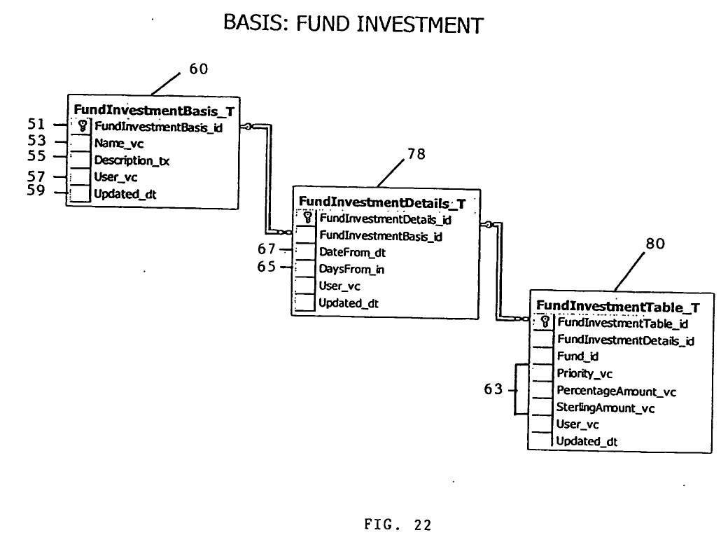

It can be appreciated from consideration of FIG. 22, therefore, that by creating appropriate instances of the tables 78 and 80 payments can be distributed in different ways at different times. By creating different instances of the table 76 of the fund investment object F1 and linking them to different instances of the underwriting and/or product object, these distributions can be controlled in different ways for different underwritings and/or products.

Auto-Switch Basis Object

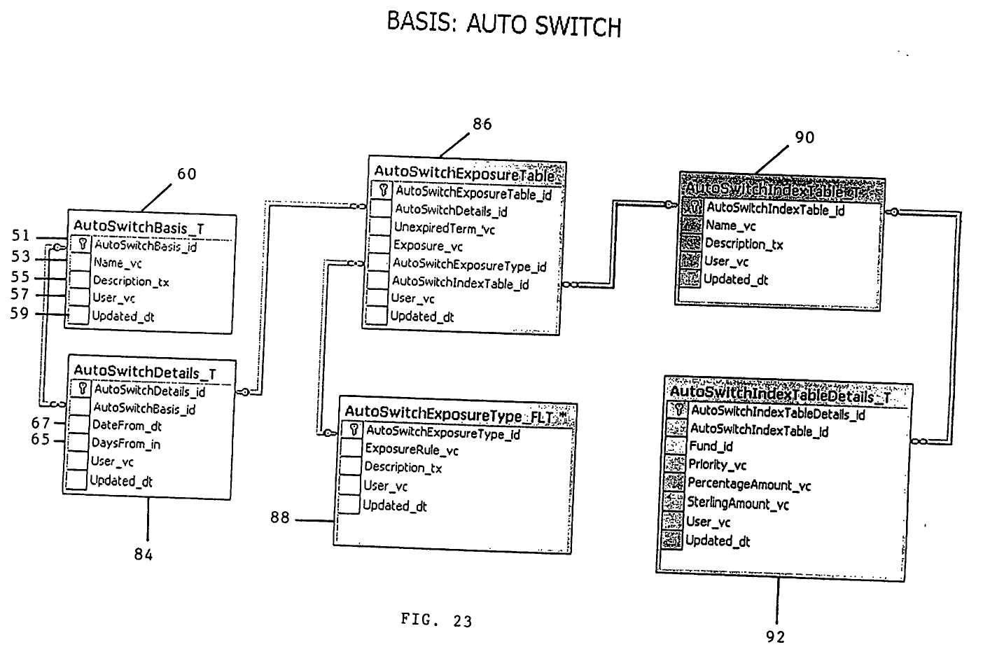

As shown in FIG. 23, the auto-switch basis object AS comprises a primary table 60 and five supplementary tables 84, 86, 88, 90 and 92.

The field 51 of the table 60 is labelled AutoSwitchBasis ID and is for linking, on the one hand, to the relevant instance or instances of the underwriting object and/or the product object and, on the other hand, to one or more instances of the supplementary table 84.

Table 84 contains the DateFrom and DaysFrom 65 and 63 which are for the same purpose as previously described. Thus, different instances of table 84 will be created as required, with appropriate values in these fields.

Each instance of the supplementary table 84 May be linked to one or more instances of the supplementary table 86 by the fields labelled AutoSwitchDetails in each of these tables.

Each instance of the table 86 may be linked to a single instance of the table 88 by the fields labelled AutoExposureType in the tables 86 and 88 and to a single instance of the table 90 by the fields labelled AutoSwitchlndexTable in the tables 86 and 90.

The table 90 may be linked to one or more instances of the table 92 by the field AutoSwitchIndexTable.

An understanding of the functions of these tables is best obtained from consideration of the following description of the process which utilises the auto switch basis object AS.

When a new product or new underwriting is set up which is to utilise the auto switch basis object AS, a scheduled pipeline process will be established for determining, in accordance with a predefined schedule, when and how often an auto switch process should be executed. The predefined schedule may, for example, cause the process to be executed daily, weekly, monthly or yearly.

Determination of whether an auto switch process is to be executed in relation to a given instance of the underwriting object first requires the relevant pipeline process (which will be initiated by the predefined schedule) to find, from examination of the DateFrom fields in the instances of the table 84, one or more instances thereof which are valid for the instance of the underwriting object in question. Having located one or more valid instances of table 84 the process then determines which of those instances, if any, contains a value in its DaysFrom field which corresponds to the current date.

If such an instance is found, the schedule pipeline process will then refer to different instances of the table 86 linked to the relevant instance of the table 84 to find an instance of table 86 in which the data in the field labelled UnexpiredTerm matches the current unexpired term of the relevant instance of the underwriting object U.

The field of table 86 labelled Exposure VC stores a threshold value which the pipeline process uses for determining whether or not a switching process is to take place. For example, the pipeline process may be set up so that if the current value of the assets as calculated from the internal fund units exceeds a certain threshold relative to the current value of the liabilities, some of the fund units would be sold in the auto switch process. In this example, therefore, the threshold value stored in the field labelled Exposure VC of table 86 could be a figure such as 0.5 or 0.75. The pipeline process would therefore calculate the assets and liabilities in the manner described with reference to FIG. 8, divide the value of the assets by the value of the liabilities and determine whether the result is above or below the threshold stored in table 86.

If the threshold is exceeded, the pipeline process refers to the appropriate instance of table 88 through the linkage established by the fields labelled AutoSwitchExposureType ID in tables 86 and 88. The field labelled ExposureRule table 88 provides a link to the rule to be followed in executing the auto switch process. This may be a simple rule, for example, “sell an equal number of units in each fund sufficient, on the basis of the current unit prices, to bring the ratio of assets to liabilities to below the threshold”. Alternatively, another simple rule might be to “sell the appropriate number of units in each fund in proportion to their relative value”.

As another alternative, table 88 may provide a more complex rule which utilises control data stored in instances of table 92 which will be accessed by the pipeline process via table 90. Such a rule may:
1. calculate the current values of the assets and the liabilities;
2. cause all units in all funds to be sold;
3. calculate the amount that has to be deducted from the asset value and used to repay capital to bring the assets/liability ratio below the threshold;
4. allocate the appropriate amount determined in step 3 to repayment of capital;
5. use the balance to link to a new spread of fund units on the basis of control data stored in table 92.

To enable execution of step 5, table 92 has four fields for containing control data. The field labelled Fund ID is for identifying the fund to which that instance of the table relates. The field labelled Priority is for assigning a priority to that instance of table 92 relative to other instances relating to different funds. The fields labelled PercentageAmount and SterlingAmount are for defining the amount to be invested in that fund in percentage or monetary terms.

It will thus be understood that when a product or underwriting is set up appropriate different instances of the tables 84 and 86 are created allowing the exposure to be managed by both a duration in force and outstanding duration. Similarly, appropriate rules are set up and linked to appropriate instances of table 88 and, where required, appropriate instances of the tables 90 and 92 are created.

In this way, simple or complex auto switch processes can easily be setup and executed by the system as required. Different instances of the underwriting and/or product objects can be linked to different instances of the primary table 60 of the auto switch basis object AS, each linked to instances of the supplementary table 84,86,88,1992 containing different control data, whereby the auto switch process applied to different underwritings can be controlled in different ways.

Payment Review Basis Object

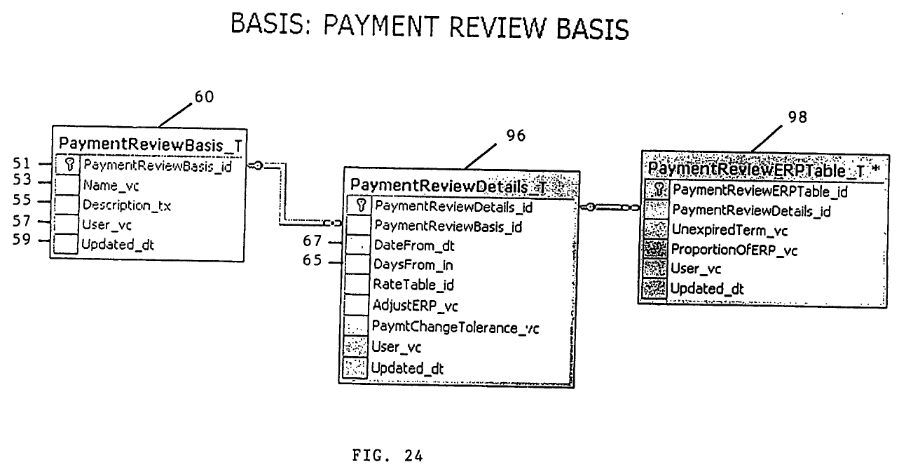

As shown in FIG. 24, the payment review basis object PR comprises a primary table 60 and two supplementary tables 96 and 98.

The field 51 of table 60 is labelled PaymentReviewBasis ID for linking to instances of the underwriting or product object.

Table 96, which is linked to table 94 by its field labelled PremiumReviewBasis ID, contains the DateFrom and DaysFrom fields 67 and 65 for the purpose previously described. Accordingly, different instances of table 96 may be set up to apply different values of the data in these fields. A number of instances of the table 96 may therefore be linked to the same instance of the table 60 of the payment review basis object PR.

The table 98 is linked to the table 96 by the respective fields labelled PaymentReviewDetails ID and contains a field labelled UnexpiredTerm. Different instances of the table 98 are set up for different unexpired terms of the underwriting object U by entering appropriate data in the UnexpiredTerm field. A number of instances of the table 98 are therefore linked to the table 96.

When setting up a product or an underwriting which is to utilise the payment review object PR a scheduled pipeline process is also defined for executing a payment review process at appropriate times, typically a few days or a week in advance of each scheduled payment which the mortgagee is to make under the terms of the mortgage.

The purpose of the payment review process is to determine whether the amount of the regular payment specified in the field labelled Amount FL in table 52 (see FIG. 13) remains an appropriate value having regard to the current amount linked to internal funds, whose value will be varied dependent upon variations in the values of the indices to which the fund prices are linked. Since, in typical use of the system, these fund prices, or many of them, will be linked to external indices whose values may increase or decrease (for example the price of shares) there is inherently a possibility that the fund values will be significantly more or less than originally expected. The payment review process involves calculations which have regard to those factors which will influence the value of the assets and liabilities at the end of the term. Relevant factors are:
1. The current values of the assets and liabilities (computation of which has been described with reference to FIG. 8).
2. The amount of the current regular payment specified in table 52.
3. The distribution of those payments having regard to the control data stored in the relevant instances of the payment target object PT, the allocation basis object AB (to be more fully described below) and the fund investment basis object FI.
4. The data in the interest and penalty interest basis objects IB and PI.
5. The equity risk premium values (explained below) stored in the field labelled EquityRiskPremium in the relevant instance or instances of the fund object.
6. Any adjustment specified in the field labelled AdjustERP in the relevant instance of table 96.
7. A rate specified in a risk free interest rate table (to be explained below) to which the field labelled RateTable ID of table 96 is linked.
8. A figure (to be explained below) in the field labelled ExpectedMortgageMargin of table 96.
9. The unexpired term as calculated from the field labelled Repayment_Date of the relevant instance of the underwriting object U.
10. The figure in the field labelled ProportionOfERP in the relevant instance of the table 98, which figure has a value selected according to the outstanding term as calculated in paragraph 8.
11. The data stored in the auto switch basis object.
12. The data stored in the auto withdrawal controlling tables (described later).
13. The data stored in the redemption penalty basis object.

The equity risk premium (ERP) is the annual percentage increase expected from the relevant fund in excess of the annual risk free rate. The annual risk free rate is the rate at which money can be invested without risk (e.g. in Government treasuries) over the same period. This risk free rate is, as already indicated, the rate in the interest rate table to which the field labelled RateTable ID of table 96 is linked.

The value chosen for the field labelled ProportionOfERP will typically be between 100% and −100%, the value being lower the shorter the remaining term. For example, the value chosen might be 100% with 20 years to run, reducing progressively to 10% with 10 years to run and further reducing progressively to −25% with 5 years to run.

An example of a simple formula that might be used for carrying out such a review is set out in Appendix I, which is to be found at the end of this description and immediately before the claims.

As with the other transaction control objects, by setting up different instances of the primary table 60, and putting different values in the appropriate fields of the supplementary tables, the payment review process may be controlled in different ways in respective different underwritings and/or products.

Allocation Basis Object

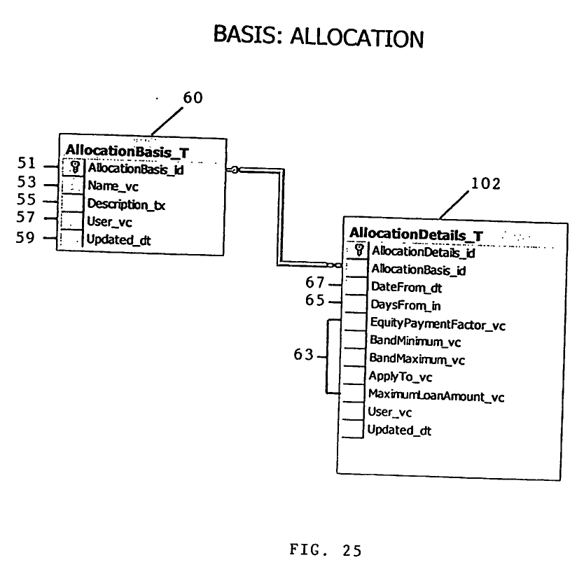

As shown in FIG. 25, the allocation basis object AB comprises a primary table 60 and a supplementary table 102.

It will now be evident that the field 51 of table 60 is for linking to instances of the underwriting object or product object.

Table 102 contains the DateFrom and DaysFrom fields which are respectively for the purposes described previously. Hence, different instances of the supplementary table 102 are created with different values for the data in these fields, and linked to the primary table 60.

The purpose of the allocation basis object AB is to make it possible to increase or decrease the amount being linked to funds, for example for awarding bonuses or deducting expenses. For this purpose, the table 102 includes a field labelled EquityPaymentFactor for storing a number, such as 1.1 or 0.95, which is to be utilised in a rule which is contained in the field labelled ApplyTo. This rule therefore governs the application of the equity payment factor. An example of the rule might be: multiply the factor by the equity element from the equity FL field of the relevant instance of the table 54.

The fields labelled BandMinimum and BandMaximum are for placing limits on the range of values of the amount being paid to funds which can be subjected to variation by the EquityPaymentFactorvalue.

As with the other transaction control objects, different instances can be linked to different instances of the underwriting and/or product objects.

Redemption Penalty Basis Object

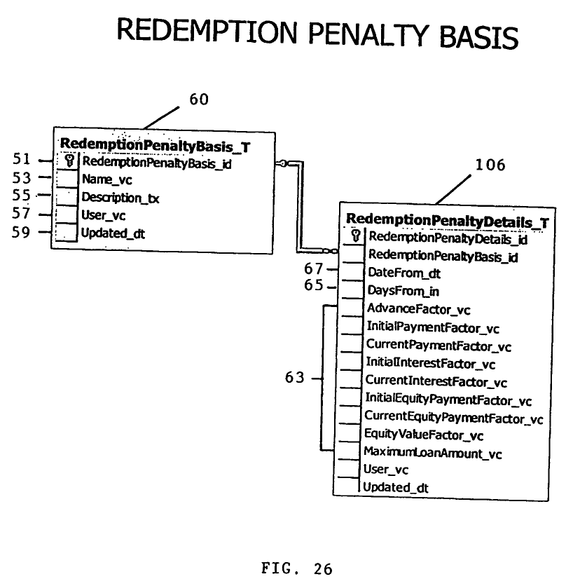

As shown in FIG. 26, the redemption penalty basis object RP comprises a primary table 60 containing the field 51 for linkage to one or more instances of the underwriting and/or product object, and a supplementary table 106.

The purpose of the redemption penalty basis object RP is to store a number of values to be used in calculating the penalty charge to be imposed if a mortgage is redeemed early.

These values are contained in the group of fields 63. In this example, this group contains eight fields each of which stores an appropriate factor for application to each of eight different parameters respectively.

Thus, in the example of FIG. 26, the redemption penalty will be calculated by taking a percentage (determined by the number in the relevant one of the fields 63) of the initial advance, the initial payment, the current payment, the initial annual interest, the current annual interest, the initial equity payment, the current equity payment and the current value of the equity, as indicated by the names of the eight fields 63.

Since in general the magnitude of the penalty will reduce with time, different instances of the table 106 will be created with successively longer period specified in the DaysFrom field 65, and each instance will store values in the abovementioned eight fields in the group 63 appropriate to the time at which the mortgage might be redeemed.

The DateFrom field 67 is for the purpose previously explained.

The field labelled MaximumLoanAmount is for specifying a figure which can be used in any of a number of different ways. For example, this figure could be used so that the relevant instance of table 106 only applies to original advances of a defined maximum value. Different instances would then be created for loans of different value.

In many cases the period of application for this object will end two or three years after the mortgage has been initiated. Termination can be effected in any of the number of different ways. One way would be by creating an instance of the table 106 which will generate a zero penalty and would come into force at an appropriate time as defined by the value stored in the DaysFrom field 65. Another way of the for the tasks employed in the pipeline process which performs the redemption penalty calculation to be set up to apply zero penalty after a time calculated from the date in the InitialDrawDownDate field in the relevant instance of the underwriting object.

### PROCESS EXECUTION OBJECTS

Pipeline Object

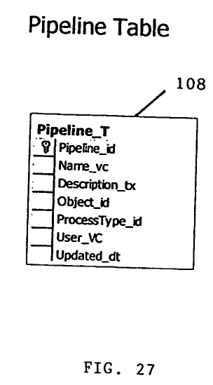

As shown in FIG. 27, the pipeline object PO comprises a table 108 having a field labelled Pipeline ID for identifying the instance of the Pipeline object, a field labelled Name for naming the pipeline, a field labelled Description for storing a description of the process and a field labelled ProcessType ID for identifying the process category to which it belongs.

Pipeline Connectors and Task Objects

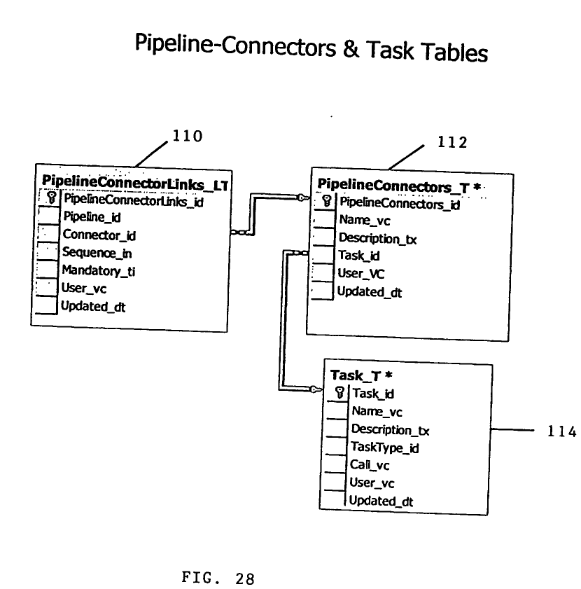

FIG. 28 shows the pipeline connector link object PCL, the connector object CON and the task object TA.

The pipeline connector link object PCL has a field labelled PipelineConnectorLinks ID, a field labelled Pipeline ID for identifying the pipeline of which it is a part, a field labelled Connector ID for linking to an instance of the connector object CON and a field labelled Sequence. This latter field is of importance in that, it will be recalled, each pipeline process may comprise a number of tasks to be performed in sequence. The Sequence field in table 110 is used to specify the order in which the instances of the pipeline connector link object 110 are to be called and therefore the order in which the tasks to which they relate will be called.

Pipeline connector object CON comprises a table 112 shown in FIG. 28. The first field is for linkage to the Connector ID field of table 110. There are fields for the name of the instance of the connector object and the description of it. The field labelled Task ID is for linkage to the relevant instance of the task object TA.

As shown in FIG. 28, the task object TA comprises a table 114 whose first field is for linking with the task ID field of the relevant instance of the table 112. There are also fields in table 114 for the name and the description of the task and for identifying the task type (in which connection it may be understood that the tasks may be grouped into different types). The field labelled Call in table 114 contains data for calling the code that constitutes the task in question.

Job Queue Object

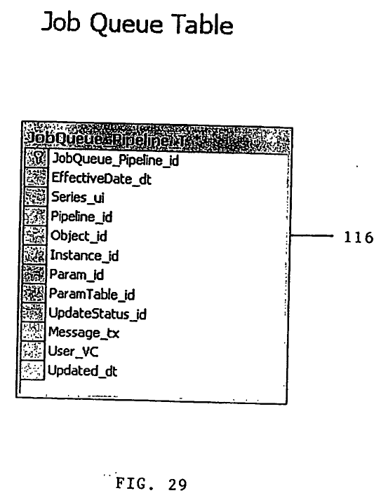

As shown in FIG. 29, the Job Queue object J comprises a table 116. It will be recalled that each new processing operation is initiated by creating an appropriate instance of the job queue object and inserting it into the job queue.

So that the correct processing operation will be performed, table 116 contains a field labelled pipeline ID which is used for linking to the fields of the same name in instances of the pipeline connector link object table 110. Thus, the correct tasks will be called in the correct order when the job is executed.

The field labelled Object ID in table 116 and the field labelled Instance ID also therein are respectively for identifying the object in relation to which the process is to be performed and the instance of that object. Financial transactions are performed on instances of the underwriting object which in turn are linked to the transaction control objects. Accordingly, it is the fields labelled Object ID (the underwriting object) and Instance ID (the instances) in table 116 which ensure that the correct control data is used when transactions are executed.

The fields labelled Object ID and Instance ID are in fact only used in relation to scheduled transactions. In the case of ad-hoc transactions, the relevant information is obtained from the ad-hoc transaction object or adjustment object to be described later, using the fields Param ID and ParamTable ID which are present in table 116.

The other fields in table 116 do not require description.

Schedule Object and Schedule Pipeline Object

It will be recalled that an instance of the schedule pipeline object SP is created for every scheduled process which is to be performed in relation to every object, specifically, so far as the invention is concerned, processes to be performed in relation to underwriting objects.

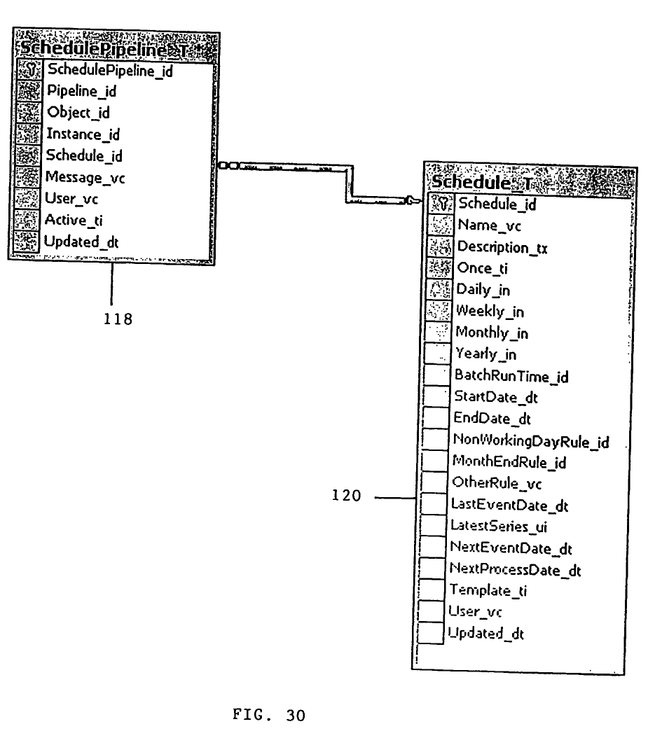

As shown in FIG. 30, the schedule pipeline object SP comprises a table 118. The first field is for identification of the instance of that object. The second field identifies the pipeline process which is to be used in the scheduled process to which that instance of the schedule pipeline object relates, the field labelled Object ID and the field labelled Owner ID respectively define the identities of the object (such as underwriting object) and the instance thereof in relation to which the scheduled process is to be performed. When a scheduled process is to be performed, therefore, the data from the pipeline ID field, object ID field and owner ID field of the relevant instance of table 118 are inserted into the new instance of the job queue table 116 which is created.

It has already been explained that the schedule pipeline object SP does not itself contain the details of the schedule which is to be followed. These details are in the schedule object SCH 120 shown in FIG. 30. The relevant instances of the tables 118 and 120 are linked by a field in each labelled Schedule ID.

Table 120 contains fields for the name and description of the instance thereof. This is followed by fields labelled Once, Daily, Weekly, Monthly and Yearly which indicate respectively whether the schedule is to be performed once and once only or whether it is to be repeated daily, weekly, monthly or yearly.

The fields labelled StartDate and EndDate specify the period for which the schedule is valid. There are three fields for specifying rules to be performed if the schedule falls on a non-working day or at the end of the month and there is a further field for specifying any other (user defined) rule. As a result, events which according to the calendar should take place on a specific date may actually be processed on a different date. The processing date may, for example, be the last working day before a Bank Holiday or weekend on which an event is due to take place, or the process date may be the following working day.

To enable processing to take place on a day different from the event date the schedule table 120 includes a field labelled NextEvenDate which is for storing the next date upon which the relevant event is due to take place and a field labelled NextProcessDate for storing the date when the event will actually be executed. The field labelled LastEventDate is the deemed date of the event, therefore, and not necessarily the date on which it was actually processed.

In order to initiate scheduled processes at the correct time, the computer constantly cycles through all instances of the schedule pipeline object SP which exist and, each time such an instance is examined, the computer then goes to the relevant instance of the schedule object SCH utilising the field labelled Schedule ID in tables 118 and 120, to determine when the next date is for performance of the process. This determination is made by examination of the field labelled NextProcessing date. At the appropriate processing date, the relevant event is processed utilising the NextEventDate in its calculations. After the process has been executed, the fields labelled LastEventDate, NextEventDate and NextProcessDate are updated.

Ad Hoc Transaction and Adjustment Objects

The system is setup to handle a number of different kinds of user instructed transaction. A unique graphical user interface is provided in component 14 for each different kind of such transaction.

So far as understanding the invention is concerned, it is only necessary to consider transactions which are executed in relation to underwritings, namely ad hoc transactions involving payments in or out or changes in fund units and transactions for the purpose of making adjustments, such as to correct errors. Each of these types of transaction is instructed utilising a respective unique graphical user interface. Examples of these will be described later.

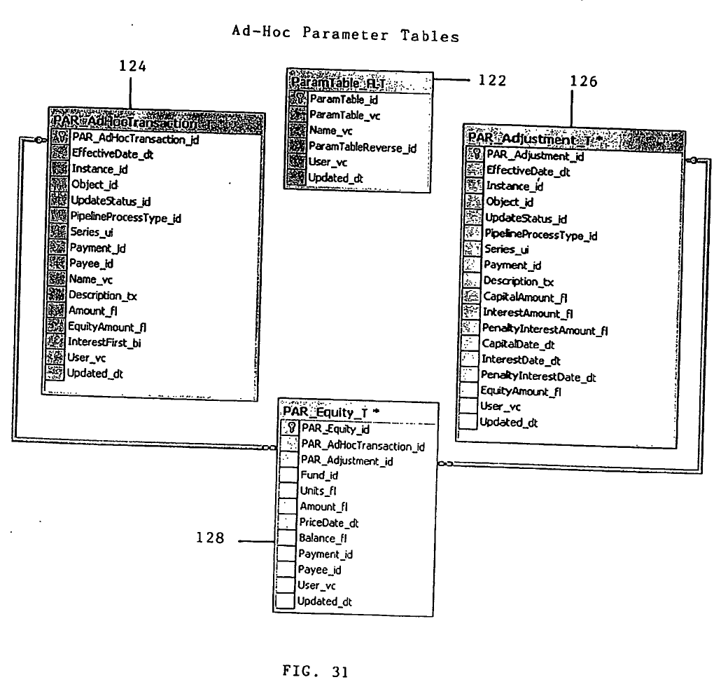

Referring to FIG. 31, tables 122, 124, 126 and 128 are provided for the purpose of executing ad hoc transactions and adjustments. Table 122 is used during the execution of these transactions. Different instances of table 122 are set up to correspond to different kinds of one of transaction. So far as understanding the invention is concerned, therefore, instances of table 122 which relate respectively to ad hoc transactions and adjustments are the ones of importance. In table 122, the field labelled ParamTable ID is for storing the identity of the instance of that table and the field labelled ParamTable VC is for storing the name of the table which will contain parameters relevant to the transaction in question. So far as the current description is concerned, there will be an instance of the table 122 in which the field labelled ParamTable VC contains the text “PAR_AdHocTransaction_T” for referring to the table 124 and another instance in which the field labelled ParamTable VC contains the text “PAR_Adjustment_T” the reference to table 126.

Table 124 and, where the transaction involves funds, table 128 are used for setting up ad hoc transactions. Tables 126 and, if funds are involved, table 128 are used for setting up adjustments. The graphical user interfaces for instructing ad hoc transactions and adjustments have fields for entering the relevant data. The program 12 is arranged so that, when the user interface for an ad hoc transaction is selected, the relevant data will be inserted in the table 124 and, if appropriate, 128; and when the interface for adjustments is selected the relevant data will be inserted in the table 126 and, if appropriate, the table 128.

If an ad hoc transaction is instructed, a new instance of table 124 is created. If the transaction does not involve purchase or sale of fund units, but only a repayment of capital and/or interest or a draw down of capital, the table 124 is used without using the table 128. In such a transaction, the amount of money is entered (via the user interface) into the field labelled Amount. The amount is negative for a repayment and positive for a draw down. The field labelled EquityAmount is left blank in this example.

Where a repayment is being made, a flag may be entered, via the graphical user interface, into the field labelled InterestFirst when interest is to be paid of f in the transaction before paying off capital. In that case, any accrued interest which has not been repaid will be paid off before the remaining part of the payment is assigned to repayment of capital.

Whenever a transaction involves an inflow of cash or an outflow of cash to or from the mortgage, a new instance of a payment object (not shown) is created for storing details of the payment and enabling the payment to be managed. The payment object will store details of the payer, the payee, the amount, the method of payment (cheque, direct debit etc.) and general ledger details. The field labelled Payment ID in table 124 (and also table 126) stores the identity of the instance of the payment object relevant to the particular transaction (or adjustment).

The fields labelled Object and Instance in table 124 (and table 126) are for storing the identity of the object (in this case the underwriting object U) and the instance thereof to which the transaction relates. The graphical user interface for ad hoc transactions (and adjustments) is accessed, in the preferred embodiment, from within a user interface relating to a specific instance of the underwriting object and accordingly these fields are filled in automatically.

If the transaction involves fund units, an instance of table 128 is created for each fund involved in the transaction. The Fund ID field is used to identify the fund to which each instance relates.

Transactions may involve purchase and/or sale of fund units and the amount involved in the transaction may be specified either in terms of the number of units or in terms of a monetary value. The fields labelled Units and Amount in table 128 are therefore used alternatively to each other to specify, as required, either the number of units or the monetary amount. Either figure may be a positive or negative number according to whether units are to be purchased or sold respectively. The PriceDate field is used for indicating (if necessary) the date of the price to be used in the transaction, for example if a transaction is performed by the user of the system a day or two later than the instruction from the customer to perform it.

When the transaction involves purchase of a specified number of units in one or more funds, the appropriate instances of the table 128 are created and the number of units to be purchased is entered in the fields labelled Units. The expected cost of these units is calculated by reference to the relevant fund price object or objects and is inserted in the field labelled Amount. This cost is not necessarily accurate because the price may have changed by the time the transaction is actually executed. By setting up an appropriate pipeline process, the system can be caused to handle any discrepancy between the estimated transaction cost and the actual transaction cost either by charging the customer the estimated cost before the transaction is executed and then making an appropriate adjustment to reflect the actual transaction cost, or by adjusting the payment object (referred to above), after the transaction has been executed, to reflect the correct payment. If the former method is used a further transaction is carried out in which an additional borrowing is made to make up any shortfall or a credit to pay of capital is made if there has been an overpayment.

When units are to be purchased or sold by specifying the amount of money to be paid or received, the relevant figure is inserted in the field labelled Amount of the or each instance of the table 128. The figure will be negative if money is to be received and positive if money is to be paid. This kind of transaction differs from that described above in which units are bought or sold by specifying the number of units in that there will be no necessity for any subsequent adjustment.

A switch transaction involves selling units in one or more funds and applying the proceeds to purchase units in one or more other funds. The net cash balance is usually zero. The field labelled Balance is used when switching is performed. Such a switch requires the following steps:
1. An instance of the table 128 is created for each fund in respect of which units are to be sold and the amount to be sold is specified as a number of units or as an amount using the fields described above. The sale of these units will realise a total amount calculated by adding together the amounts realised from each individual fund.
2. In order to link this total amount to one or more other funds, a further instance of table 128 is created for each such other fund. The field labelled Balance is used to specify, for each such other fund, the percentage of the total realised amount to be linked to that fund.

After the user has entered the data required for the ad hoc transaction into the relevant user interface, and he is satisfied with it, he instructs the transaction to be executed by pressing an appropriate button on the user interface. In response to this instruction, the system creates a new instance of the job queue object in which the identity of the relevant instance of table 122 is inserted in the field labelled ParamTable ID and the identity of the relevant instance of table 124 is inserted in the field labelled Param ID. For the job to be executed, the identity of the pipeline process to be used must also be inserted into the appropriate field of the instance of the job queue object. The manner in which this is achieved will be described later with reference to FIG. 31.

When the job is executed, the relevant instance of table 124 is accessed, by the pipeline process, by firstly locating the for relevant instance of table 122 using the data in the ParamTable ID field of the job queue object and then locating the instance of table 124 using the data in the Param ID field of the job queue object. Strictly, it would be possible to omit reference to the table 122 and go directly to the instance of table 124 using its identity which is in the Param ID field of the job queue object. However, the table 122 is included in the system because it is used to standardise all ad-hoc processes and facilitates adding new ad hoc processes to the system as required in the future.

Adjustments are handled in an analogous way to ad hoc transactions but using the table 126 instead of the table 124 and, if required, instances of the table 128 (when funds are involved). Adjustments to capital, interest, penalty interest or equity are made by inserting the figure required for the adjustment, by the relevant user interface, into respective ones of the field labelled CapitalAmount, InterestAmount, PenaltyInterestAmount or EquityAmount as appropriate.

The fields labelled CapitalDate, and InterestDate, PenaltyInterestDate are used for storing the date to which interest is assumed to have been charged in relation to, respectively, adjustments involving capital, interest and penalty interest. Processes in which interest is calculated will then only add interest in respect of positive adjustments, or negative interest in respective negative adjustments, for periods subsequent to the interest paid to date.

Auto Pipeline Object

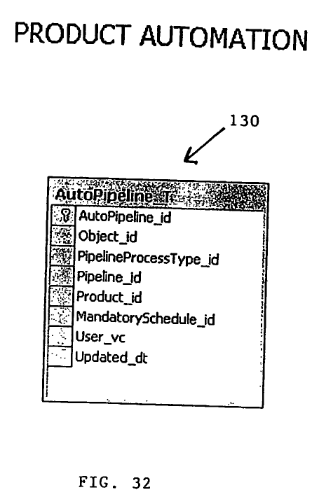

With reference to FIG. 32, the auto pipeline object APO comprises a table 130 a having a field labelled AutoPipeline ID for storing the identity of the relevant instance, a field labelled Object ID for identifying the object with which it is to be used (for example the underwriting object), a field labelled PipelineProcessType ID for identifying the type of pipeline process to which it relates, a field labelled Pipeline ID for identifying a specific pipeline process and a field labelled Product ID for identifying the product which it relates.

The field labelled MandatorySchedule ID is used to store values which indicate the circumstances in which the relevent instance of the auto pipeline object can be employed. By way of example, the data which could be entered in this field might have one of two values, typically 0 or 1. In one example, the value 0 is used to indicate instances to be employed in ad hoc transactions and adjustments. The value 1 is employed to instruct the system to create a new instance of the schedule pipeline object SP in response to the creation of a new instance of the underwriting object U. The purpose here is to automate the selection of the one or more instances of the schedule pipeline object SP whenever a new instance of the underwriting object U is created.

The function of the relevant instance of the auto pipeline object when an ad hoc transaction or an adjustment is performed is to provide to the job queue object the identity of the pipeline process to be used in executing the transaction. This identity is contained in the field labelled Pipeline ID of the relevant instance of the table 130. The relevant instance is identified, when the job queue instance is setup for execution of the relevant process, by matching the data in the PipelineProcessType ID field of table 124 or table 126 (as the case may be) with the corresponding field in table 130 and matching the data in the Product ID field of table 130 to the identity of the product linked to the underwriting in relation to which the transaction is being performed.

It will accordingly be appreciated that when a product is set up, an appropriate instance of the auto pipeline object to be used for ad hoc transactions and adjustments is also set up, together with the identity of the pipeline process (as already described above) which is to be executed when ad hoc transactions and adjustments are performed.

Other instances of the auto pipeline object are also setup, as necessary, when new products are setup for the purpose of automatically selecting the required pipeline process to be used in the transactions which are to be executed in relation to that product, for example interest rate calculations.

Thus a product can be configured to cause the Underwriting object to behave specifically as required in respect of both regular scheduled transactions and one off transactions.

### TRANSACTION TABLE

It has already been explained that the table illustrated in FIG. 8 is a simplification of the transaction database and that the actual table has more fields than indicated in connection with FIG. 8.

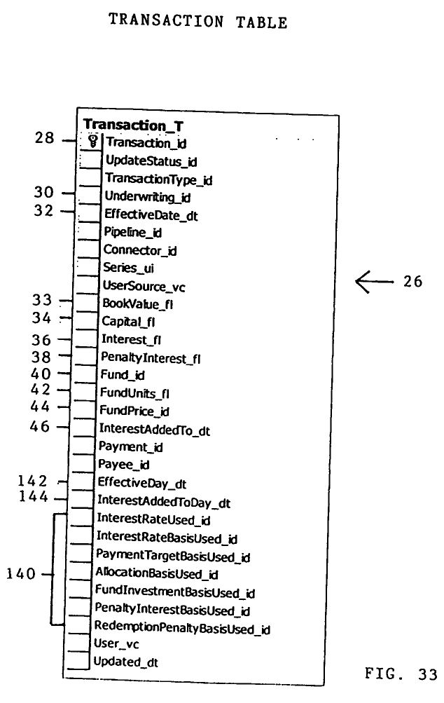

Fields in FIG. 33 which correspond to columns in the table shown in FIG. 8 are identified with the same reference numbers.

It can be seen from FIG. 33 that additional fields are provided for the type of transaction, the identity of the pipeline process used, the identity of the instance of the connector object CON used, and identification references for the payment and payee.

There is also a group of fields 140 for indicating the instances of the transaction control objects of FIG. 3 that were used. The labelling in these fields will be self-explanatory.

In addition to the effective date field 32 and the interest added to date field 46, there are two fields 142 and 144 labelled EffectiveDay and InterestAddedToDay.

In this embodiment of the invention, the field 32 includes a time stamp as explained already for recording the exact time of the transaction and if relevant the exact time up to which interest has been calculated. Field 142 does not include a time stamp and is merely for recording the date of the transaction. Similarly, field 144 concerns interest calculations only up to a given day rather than to a given time at a given time at a given day.

The remaining fields are not relevant to the invention and need not be described.

### USER INTERFACES

Overview of the Interfaces

FIGS. 34 to 46 illustrate examples of a number of user interfaces which may be provided in component 14.

The user interface shown in FIG. 34 is for making selections from and/or accessing instances of the transaction control objects, or for setting up new instances thereof. It may be accessed, for example, through an interface for setting up the new product or through an interface for displaying details relating to specific mortgages, i.e. specific instances of the mortgage object M.

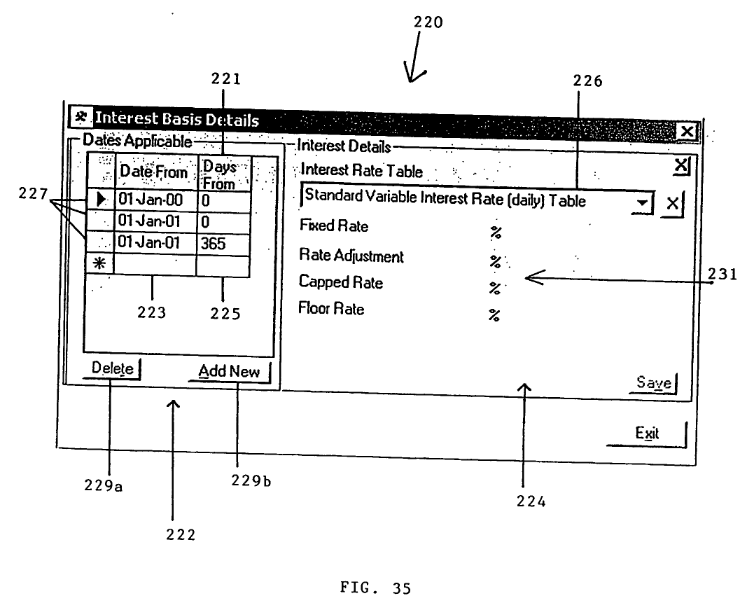

The user interfaces shown in FIGS. 35 to 43 each relate to a respective different one of the 8 transaction control objects shown in FIG. 4. These interfaces are for entering values for the time control data and the transaction control data which is stored in the respective different instances of each of the transaction control objects. To facilitate these operations, each of these interfaces, as will become apparent, comprises a first panel, identified by reference number 222 in FIGS. 35 to 43, for entering the time control data into the fields 65 and 67 of the appropriate tables shown in FIGS. 19 to 26, and a further panel or panels for entering the transaction control data into the fields 63 of those tables.

The user interfaces of FIGS. 35 to 43 may be accessed through the user interface of FIG. 34 or through interfaces (which it is not necessary to illustrate) which relate to specific mortgages, i.e. specific instances of the mortgage object M. They may be employed for entering control data values into new instances of the transaction control objects or for editing the control data in existing instances thereof.

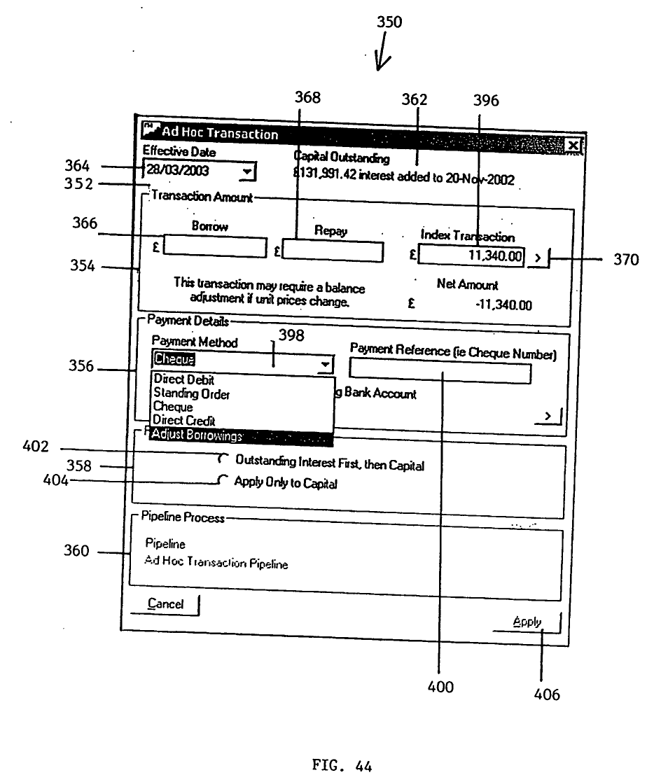

FIGS. 44 to 46 illustrate user interfaces for instructing ad hoc transactions and adjustments. These interfaces are accessed exclusively in relation to specific underwritings i.e. specific instances of the underwriting object U so that the identity of the underwriting object in relation to which the ad hoc transaction or adjustment is to be performed is automatically defined.

Interface for Selecting Transaction

Control Objects

With reference to FIG. 34, a user interface 200 for selecting transaction control objects, and different instances thereof, has a set of eight drop down menus 202, 204, 206, 208, 210, 212, 214 and 216. These menus correspond respectively to the interest basis object IB, the payment target object PT, the allocation basis object AB, the fund investment basis object FI, the penalty interest basis object PI, the redemption penalty basis object RP, the auto-switch basis object AS and the payment review basis object PR.

The items on these drop down menus correspond to different instances of the transaction control objects to which they respectively relate. Each drop down menu will provide a list of different bases. The name for each basis which is displayed in the list will be the name stored in the field 53 of the respective instance, as described with reference to FIGS. 19 to 26.

The interface of FIG. 34 may be accessed when a particular underwriting arrangement or new product is being set up, so that the user may make selections from the drop down menus to provide the combination of instances of the transaction control objects required.

It may also be accessed when it is desired to modify any of the data stored in any instances of any of the objects. In this case, the instance of the object to be modified may be accessed by selecting it from the appropriate one of the drop down menus 202, 204, 206, 208, 210, 212, 214 and 216. This selection will cause the relevant one of the user interfaces shown in FIG. 35 to 43 to be displayed and the data displayed varying will be the data stored in the relevant instance of the tables of FIGS. 19 to 26.

Interface for Interest Basis Object

FIG. 35 shows a user interface 220 for setting up and displaying an instance of interest basis object IB. This interface comprises two panels 222 and 224.

The panel 222 is for entering time control data into the DateFrom and DaysFrom fields 67 and 65 of table 62 in FIG. 19. For this purpose, the panel 222 comprises a table 221 having a column 223 containing fields corresponding to the DateFrom field 67 and column 225 containing fields corresponding to DaysFrom field 65. As shown, the table 221 accordingly comprises a number of lines 227, each values for the DateFrom and DaysFrom data. Each line 25 accordingly corresponds to a respective different instance of the table 62 shown in FIG. 19.

The panel 222 is provided with a delete button 229a for deleting a selected one of the lines 227, and therefore deleting the corresponding instance of table 62, and an add new button 229b for adding, one at a time, new lines 227 and thereby creating new instances of the of table 226. Thus, every time a new line is added, a new instance of table 62 will be created.

The lines 227 can be individually selected and the panel 224 is arranged to display data derived from the fields 63, shown in FIG. 19, of the instance of table 62 which corresponds to the selected one of the lines. The panel 224 comprises a window 226 which displays the name of the interest rate table employed. This is derived from the instance of the interest rate tables 56 and 58 (FIG. 18) to which the incidence of table 62 is linked via the field RateTable ID. A drop down menu (not shown) can be displayed for selecting other interest rate tables and inserting them names in the window 226 in a conventional manner.

The panel 224 also has a group of fields 231 which correspond to the fields labelled FixedRate, RateAdjustment, CappedRate and FloorRate in the group of fields 63 of table 62 of FIG. 19. These fields accordingly display the corresponding values of the data stored in the relevant instance of table 62.

It will now be appreciated that new instances of table 62 may be easily created by inserting data into a new line using the “add new” button in the panel 222 and then choosing the rate table from the drop down menu and putting any required values in the fields 231.

The program also includes provision for setting up new interest rate tables, but this provision need not be described.

Interface for Penalty Interest Basis Object

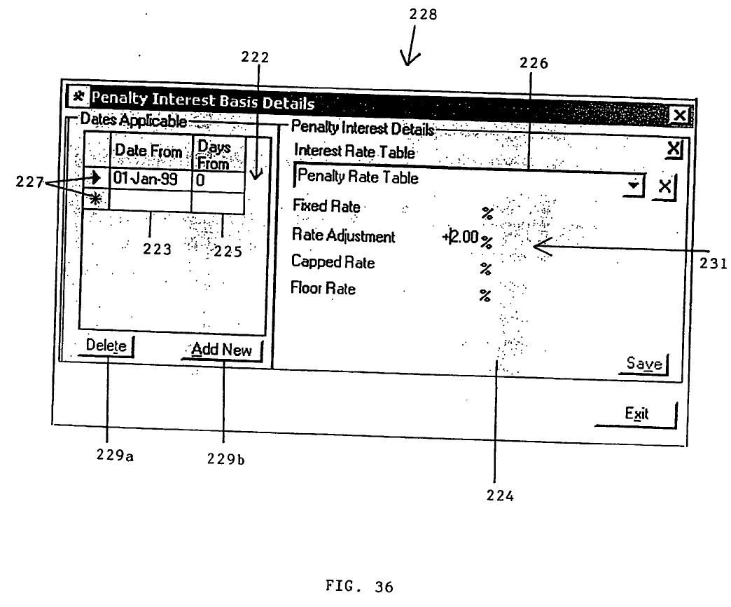

FIG. 36 shows a user interface 228 for setting up an instance of the penalty interest basis object, or displaying data from instances thereof.

Apart from the fact that this user interface is for penalty interest, it is identical to the user interface shown in FIG. 34 but relates to the tables 60 and 62a of FIG. 20. Corresponding elements are indicated in FIG. 36 with the same reference numbers as used in FIG. 35 and therefore need not be described any further.

Interface for Payment Target Object

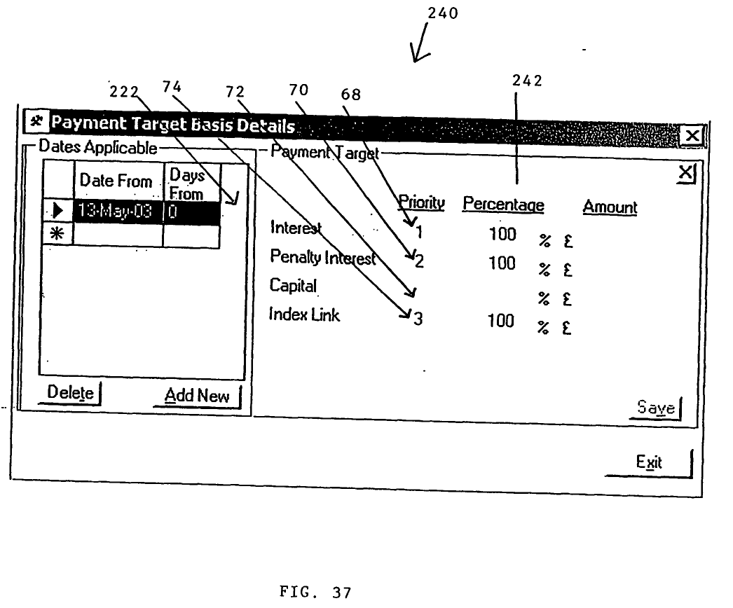

FIG. 37 shows a user interface 240 for setting up payment target basis details.

This includes a panel 222 which is identical to the panel 222 of FIGS. 35 and 36 but in this case the panel relates to table 66 of FIG. 21. Each line of panel 222 therefore corresponds to a different instance of table 66. New instances thereof may be created by adding lines to the panel 222 using the “add new” button 229b.

Panel 242 in user interface 240 has four groups of fields which correspond to the groups 68, 70, 72 and 74 shown in FIG. 21. These groups are therefore indicated by the same references as are used in FIG. 21 and are for entering data into the corresponding fields for controlling transactions which take place.

As in the case of the user interface of FIG. 34, selecting a line of panel 222 causes the data from the corresponding instance of table 66 to be displayed in panel 242.

The user may modify or add to this data at will.

Interface for Fund Investment Basis Object

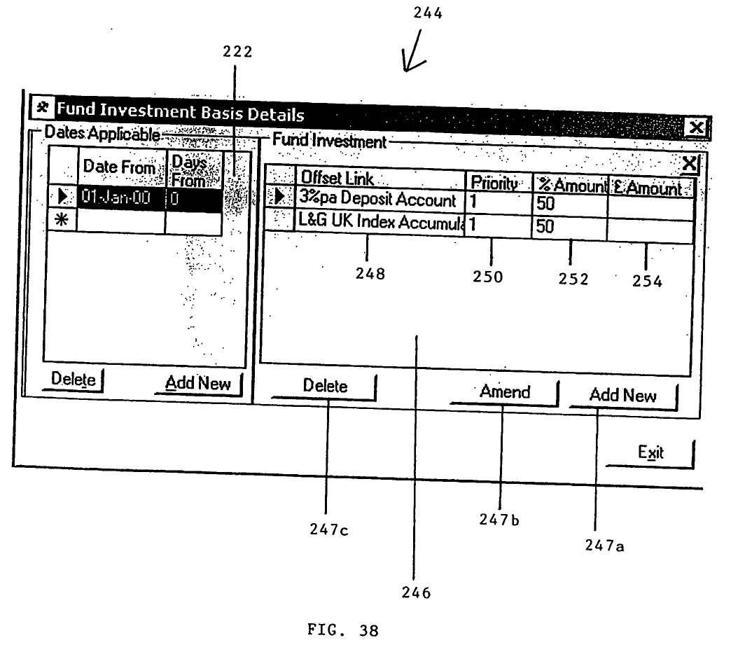

FIG. 38 shows a user interface 244 comprising a panel 222 and a panel 246

The panel 222 is as described previously but in this case relates to the table 78 in figure. Each line of panel 222, therefore, corresponds to a different instance of table 78 in FIG. 22.

Panel 246 includes a table in which column 248 lists the funds to which payments are to be directed, column 250 indicates the priority to be given to the respective funds and columns 252 and 254 respectively are for specifying the manner in which payments are to be distributed between the funds by percentage or monetary amount respectively. Each line of the table in panel 246, therefore, corresponds to a different instance of table 80 shown in FIG. 21. Selecting a line in the panel 222, as with the previously described interfaces, causes the data from the corresponding instance of table 80 of FIG. 21 to be delayed.

Using the “add new” button 247a in panel 246, new lines can be added to the table in that panel thereby creating new instances of the table 80. Instances of the table 80 can be amended or deleted respectively utilising the amend button 247b all the delete button 247c.

Interface for Auto Switch Basis Object

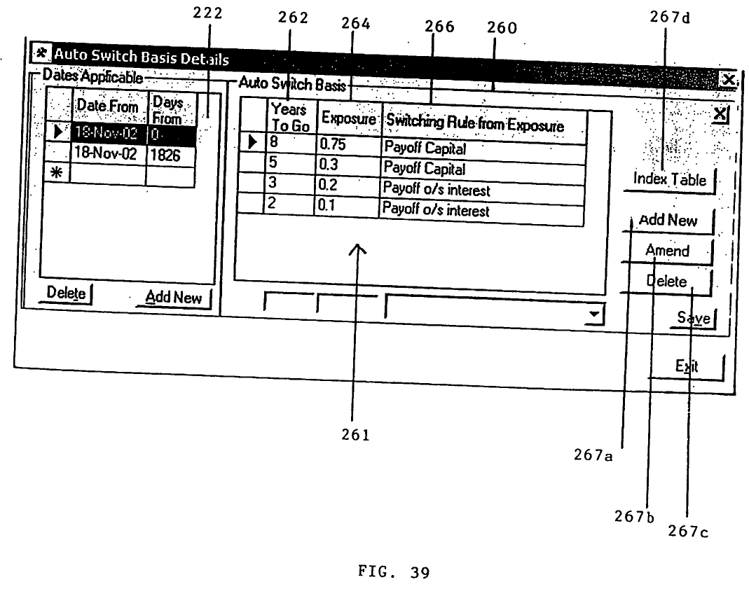

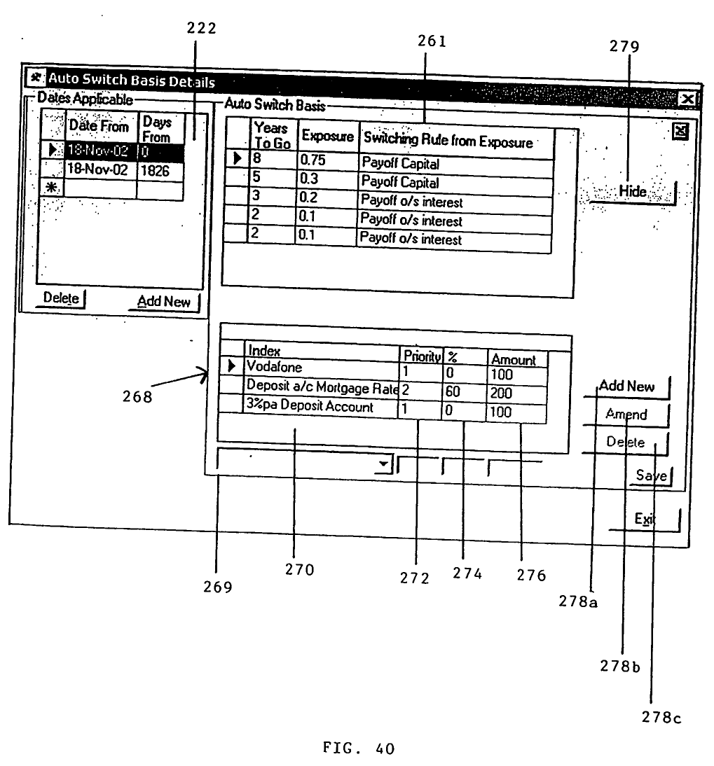

FIGS. 39 and 40 show user interfaces for setting up or amending instances of the auto-switch basis object AS.

As shown in FIGS. 39 and 40, there is a panel 222, which is as previously described, but in this case for specifying DateFrom and DaysFrom data in table 84 of FIG. 23, each line 227 of panel 222 corresponding to a different instance of that table.

The interface shown in FIG. 39 includes a further panel 260 which contains a table 261 having three columns 262, 264 and 266 which correspond to the fields labelled UnexpiredTerm and Exposure of table 86 in FIG. 23 respectively and for defining a switching rule. Different lines in the table 261 correspond to different instances of the table 86 of FIG. 23. New lines, and therefore new instances of table 86, can be created utilising the add new button 267a provided in panel 260. Existing lines, and the corresponding instances of table 86, can be amended or deleted using the amend or delete button 267b or 267c respectively, which are also provided in the panel 260.

Selecting a line in the table 261 and pressing the index table button 267d provided in panel 260 causes a further panel 268 to be displayed which, as shown in FIG. 40, comprises a table 269. The contents of table 269 which are displayed correspond to the selected line of table 261.

The table 269 corresponds to the table 92 shown in FIG. 23 and the columns 270, 272, 274 and 276 thereof correspond respectively to the fields labelled FundPriority, PercentageAmount and SterlingAmount in table 92. Each line of the table 269 corresponds to a different instance of table 92.

Further instances of table 92 can be created by adding new lines to the table 269 using the “add new” button 278a provided in the panel 268. Instances of the table 92 can be amended or deleted respectively using the amended button 278b or the delete button 278c also provided in the panel 268.

A button 279 labelled “hide” appears when the panel 268 is displayed and is for closing the panel 268.

Interface for Payment Review Basis Object

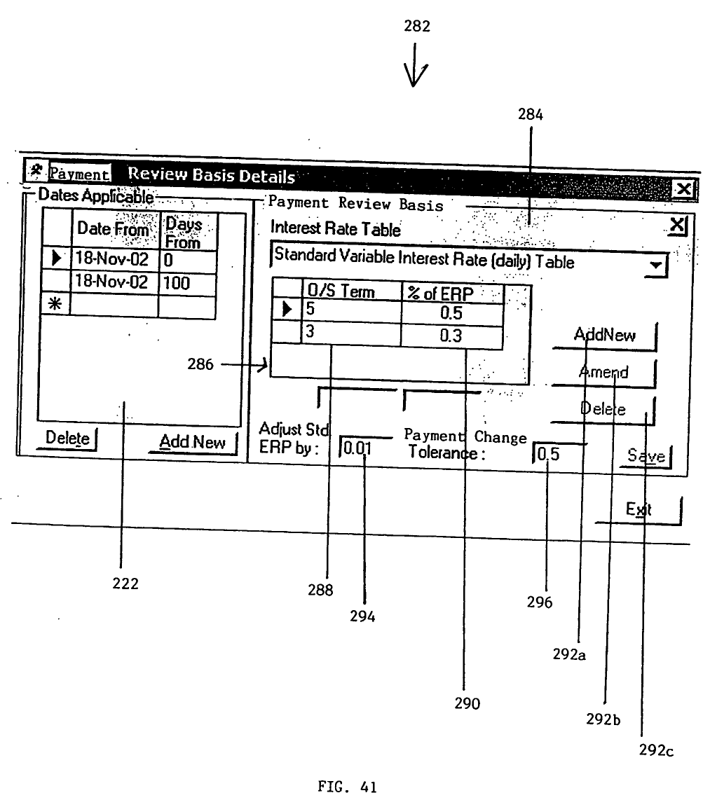

FIG. 41 shows a user interface 282 for setting up and amending instances of the payment review object PR. This comprises a panel 222 and a panel 284.

The panel 222 is as previously described but, in this case, each line 227 corresponds to a different instance of table 96 shown in FIG. 24

The panel 284 includes a table 286, columns 288 and 290 of which correspond to the fields labelled UnexpiredTerm and ProportionOfERP of table 98 shown in FIG. 24. Each line of table 286, therefore, corresponds to a different instance of table 98. New lines can be added by pressing the “add new” button 292a, thereby creating a further instance of table 98, and appropriate data inserted. Lines can be amended or deleted, together with the corresponding instances of the table 98, utilising the buttons 292b and 292c respectively.

Fields 294 and 296 of panel 284 correspond to the fields labelled AdjustERP and PrmChangeTolerance of table 96 in FIG. 24. Each instance of table 96 is therefore linked to a unique instance of table 98.

Interface for Allocation Basis Object

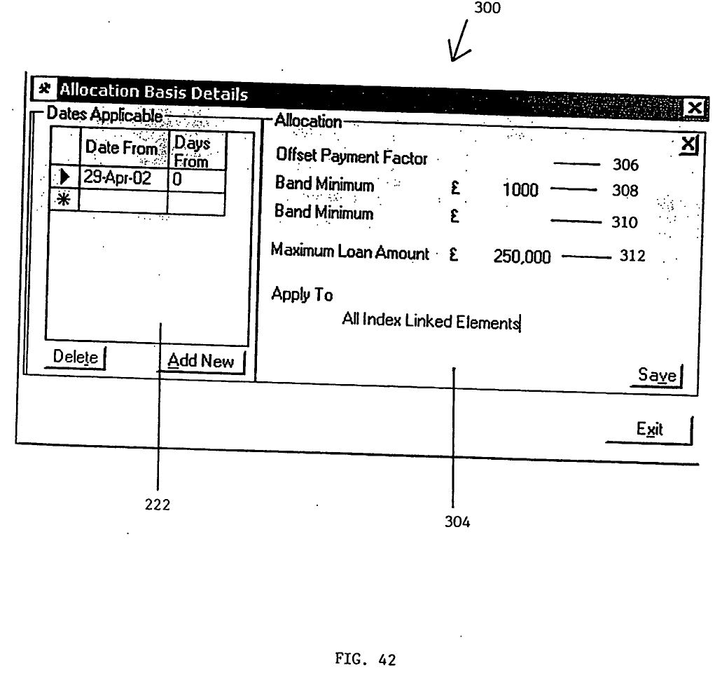

FIG. 42 shows an interface 300, comprising panels 222 and 304, for setting up or amending instances of the allocation basis object AB.

The panel 222 is as previously described that in this case relates to the table 102 of FIG. 25.

The panel 304 contains four fields 306, 308, 310 and 312 which correspond respectively to the fields labelled EquityPaymentFactor, BandMinimum, BandMaximum and MaximumLoanAmount of table 102. As with the other user interfaces described, the data displayed at any time in panel 304 corresponds to the selected line in panel 222.

Interface for Redemption Penalty Basis Object

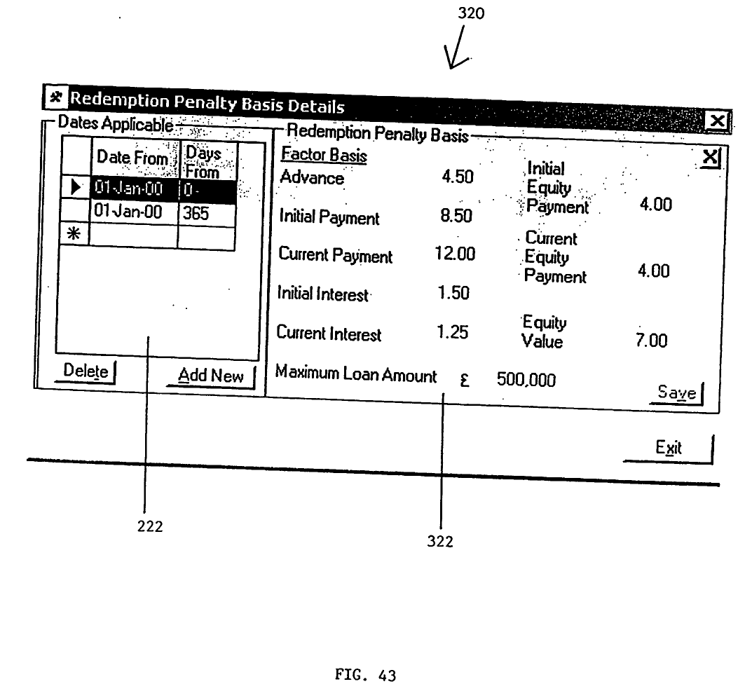

FIG. 43 shows a user interface 320 comprising a panel 222 and a panel 322, for setting up and amending instances of the redemption penalty basis object RP.

The panel 222 is as previously described but in this case relates to the table 106 of FIG. 26. Thus, different lines of this panel correspond to different instances of table 106.

Panel 322 contains nine fields which correspond respectively to similarly identified fields in table 106 as shown in FIG. 26. The data displayed in panel 322 corresponds to the selected line in panel 222.

Interfaces for Ad Hoc Transactions

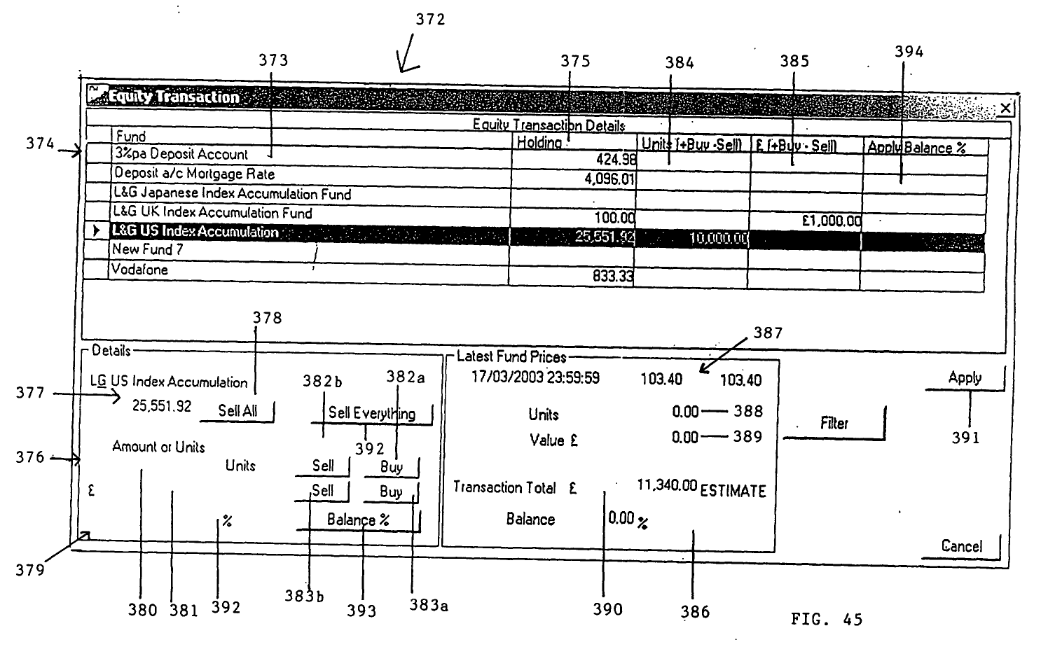

FIGS. 44 and 45 illustrate user interfaces 350 and 372 for entering data to be used in an ad hoc transaction. The data which is entered with the assistance of these interfaces is transferred to appropriate fields of appropriate instances of the tables 124 and 128 which are illustrated in FIG. 31 and have already been described.

When an ad hoc transaction is to be instructed, the table 350 shown in FIG. 44 is downloaded to one of the client computers 4. The program 12 is arranged so that the interface 350 can only be accessed from an interface (not shown) related to a specific underwriting i.e. a specific instance of the underwriting object U. The program 12 is further arranged so that downloading of the interface 350 to one of the client computers 4, for the purpose of instructing an ad hoc transaction, causes a new instance of table 124 shown in FIG. 31 to be created in which the identity of the underwriting object U and the relevant instance thereof are inserted automatically into the fields labelled Object ID and Instance ID. This ensures that the ad hoc transaction instructed takes place on the required instance of the underwriting object U.

The interface 350 comprises five panels 352, 354, 356, 358 and 360. As a consequence of downloading the interface 350, the program 12 computes the capital outstanding in relation to the particular underwriting and displays the result in handle 352 as indicated by reference number 362. The data displayed at 362 also indicates the date to which interest has been added. The effective date of the transaction, i.e. the date on which it is to be executed is inserted in a window 364 in panel 352. This can be automatic (today's date) or manually inserted, for example from a drop down menu.

The panel 354 contains a field 366 and a field 368 respectively for entering the amount of money to be borrowed or repaid, as the case may be, in the ad hoc transaction which is being set up. The amount inserted is entered into the field labelled Amount in table 124 and is indicated therein as being positive or negative according to whether money is being borrowed (using field 366) or repaid (using field 368).

If the transaction is to involve purchase or sale of units in one or more funds, a button 370 in the panel 354 is pressed to download a further user interface 372 which is shown in FIG. 45. This displays in column 373 of a table 374 a list of all available funds. Column 375 of table 374 displays the current number of units (if any) in each fund held by the relevant underwriting. These figures are calculated and displayed automatically by the program 12 when the table 372 is opened.

The interface 372 also comprises a data entry panel 376 for specifying the transaction or transactions to take place in respect of one or more of the funds listed in column 373. The panel 376 is made active in relation to a given fund by selecting the line of column 373 which contains the name of the required fund. The name of the fund selected appears at region 377 in panel 376 together with the currently held number of units in that fund. A button 378 is provided in panel 376 for clicking if it is desired to sell all of the units currently held in the selected fund. Region 379 of the panel 376 contains a field 380 for indicating the number of units in the selected fund to be bought or sold and field 381 for specifying the monetary value of units in the selected fund to be bought or sold. The fields 380 and 381 are used alternatively. Buy and sell buttons 382a and 382b are provided for respectively instructing purchase or sale of the number of fund units specified in field 380, if that field is used, and buy and sell buttons 383a and 383b are provided respectively for instructing buying or selling of units to the value specified in field 381 when that field is used. Clicking on the appropriate one of these four buttons enters the number of units to be bought or sold into column 384 of table 374 or the value of the units to be bought or sold into column 385 of table 374, as the case may be.

When a fund is selected, the latest stored price for the fund is displayed in panel 386 of the interface 372 in region 387 of this panel. The number of units involved in the transaction or the value is indicated in the field 388 or 389, as the case may be, and the estimated value, where the transaction is on the basis of a specified number of fund units, is displayed in the field 390. The latter value can only be an estimate since, by the time the transaction is executed, the unit price of the fund may have changed.

The preparation of a transaction utilising the user interface 372 causes a new instance of the table 128 shown in FIG. 31 to be created. As already described with reference to FIG. 31,a separate instance of table 128 is created for each fund involved in the ad hoc. transaction. The data which is entered into user interface 372 is also entered into the relevant fields of the relevant instance of table 128. This is effected by actuating the Apply button 391 provided in user interface 372.

If it is desired to sell all units in all funds, this can be achieved by clicking on button 392 provided in panel 376 of the interface 372.

When the transaction involves sale of fund units, the resulting proceeds can be used for the purchase of units in a different fund of funds, or can be partially or completely redistributed amongst the number of the funds. This is achieved by selecting, one at a time, the lines of table 374 which relate to the funds in which it is required to purchase units and specifying, in relation to each such fund, the percentage of the proceeds to be applied thereto using the field 392 in panel 376. The button 393 is activated in order to transfer the figure specified in field 392 to the relevant field in column 394 of table 374.

After the transactions involving funds have been specified using interface 372, and appliedall of you a advocate of using the button 391 thereof, the total value of the fund transactions appears in field 396 of panel 354 of user interface 350. At this point, the interface 372 disappears.

Field 398 in panel 356 is for specifying the manner in which payment is to be made, in or out, and field 400 is for indicating a payment reference.

Button 402 in panel 358 is for entering the flag to indicate that, when a payment is made, priority should be given to paying off interest. Button 404 also in panel 358 is for indicating that the payment in should be only applied to paying off outstanding capital.

Panel 360 indicates the nature of the pipeline process which will be used for executing the transaction.

When an ad hoc transaction has been setup with the assistance of user interfaces 350 and 372, the instruction to execute it is entered by pressing the Apply button 406 on user interface 350. The transaction then gets executed in the manner described with reference to FIG. 31.

Interface for Adjustments

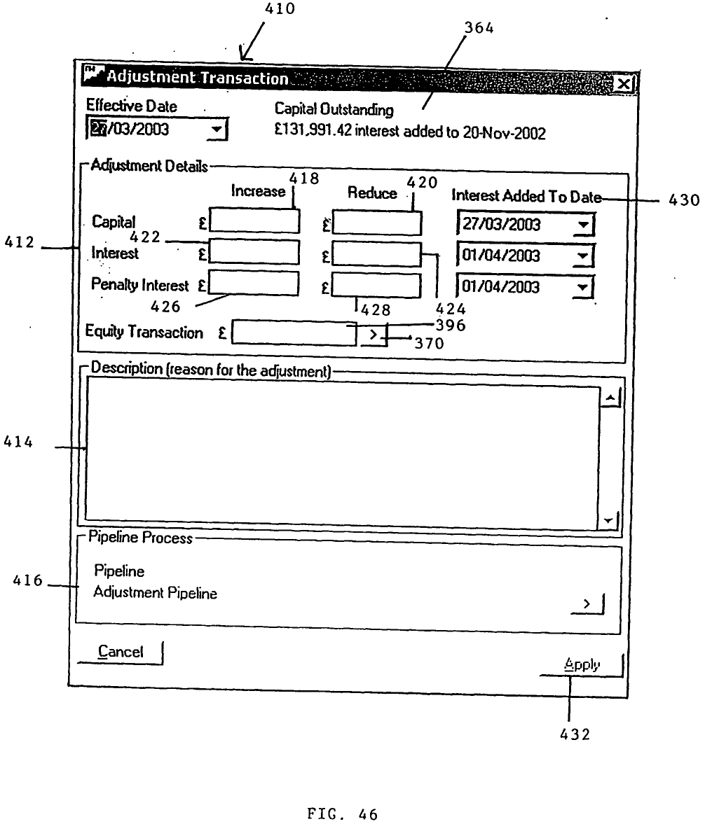

FIG. 46 shows a user interface 410 for instructing adjustments. Like the interface of FIG. 44, this can only be accessed from an interface (not shown) relating to a specific instance of the underwriting object, to ensure that the adjustments is performed in relation to the appropriate underwriting. Downloading the interface causes a new instance of the table 126 shown in FIG. 31 to be created.

The interface 410 includes a panel 364, which is the same as a panel 364 in FIG. 44, a panel 412 for entering data to define the adjustment, a panel 414 for entering descriptive material, particularly for explaining the reason for the adjustment, and a panel 416 which displays the identity of the pipeline process which will be employed in the adjustment.

The data entry panel 412 comprises a pair of fields 418 and 420 for specifying respectively the amount by which capital is to be increased or decreased, a pair of fields 422 and 424 for specifying the amount by which interest is to be increased or decreased and a pair of fields 426 and 428 for specifying respectively the amount by which penalty interest is to be increased or decreased. The fields 418,420, the fields 422,424 and the fields 426,428 correspond respectively to the fields labelled CapitalAmount, InterestAmount and PenaltyInterestAmount of table 126 in FIG. 31. The three fields in column 430 of panel 412 are for specifying the respective dates to which interest is assumed to have been added in relation to, respectively, the capital adjustment, the interest adjustment and the penalty interest adjustment.

The panel 412 also includes a button 370 and field 396 which serve the same function as the correspondingly referenced items in panel 354 of user interface 350. Thus, pressing the button 370 in panel 412 accesses the interface 372. This is utilised in an adjustment in precisely the same way as it is utilised in an ad hoc transaction, and consequently need not be described further.

User interface 410 includes an Apply button 432. When this is actuated, after setting up the adjustment transactions using the interface 410 and if required the interface 372,the data which has been entered is transferred to the table 126 and (if fund units are involved) to the appropriate number of instances of table 128 created for the purpose of the adjustment.

### MODIFICATIONS

Automatic Withdrawal Facility

A unique advantage which is available to mortgagees whose mortgages are managed by a system according to the preferred embodiment of the invention, in which sums of money are linked to funds whose values may vary, is the possibility of providing automatic payments out (withdrawals) funded by selling units in funds and/or drawing down additional capital.

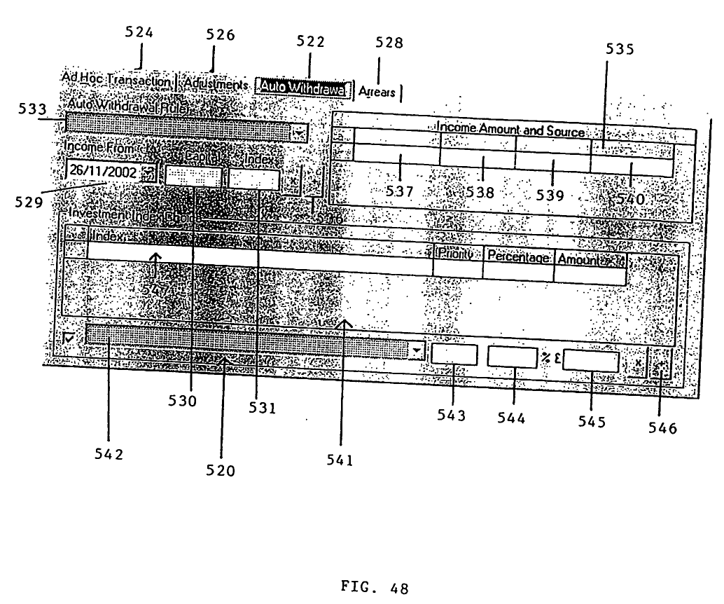

FIGS. 47 and 48 show respectively a set of data tables and a corresponding user interface for implementing this facility.

With reference to FIG. 47, a table 500 has a field 502 for linking the table 500 to the underwriting object U. When an automatic withdrawal process is set up in relation to a specific instance of the underwriting object U, a new instance of the table 500 is created and linked to the relevant instance of the underwriting object. It is possible to set up a number of different automatic withdrawal processes in relation to each underwriting, the different processes to be executed at different times. Each automatic withdrawal process requires its own instance of table 500.

The field 503 is used to specify the date upon which income from the automatic withdrawal process should begin. The fields 504 and 506 are for specifying the amount of money to be paid out each time the auto withdrawal process is executed. The field 504 is used to indicate how much (if any) is to be drawn by making an additional capital borrowing and the field 506 is used for specifying how much (if any) is to be drawn by selling fund units.

Table 508 is used if fund units are to be sold to provide some or all of the money to be drawn. A separate instance of table 508 is created in relation to each fund from which units are to be sold. These instances are linked to the relevant instance of table 500 by the fields 510 and 512 in the tables 500 and 508 respectively. The fields 543, 544 and 545 in table 508 labelled Fund ID, Priority, Percentage and Amount have the same purpose as described in relation to similarly identified fields described above in relation to tables relating to distribution of positive or negative payments relating to funds.

Field 514 in table 500 is for linking the relevant instance of that table to an instance of table 516 which is for specifying the rule to be followed in the automatic withdrawal process. An example of a rule might be that the automatic withdrawal process should not be executed if the assets, following the transaction, would be less than certain value. As can be seen in FIG. 47, this table has fields for the name and a description of the rule. The frequency and timing of the automatic withdrawal processes could be defined in the rule or alternatively could be defined in a scheduled pipeline process for executing the auto withdrawal process.

FIG. 48 shows a user interface 520 for setting up automatic withdrawal processes. As with the interfaces 350 for ad hoc transactions and 410 for adjustments (FIGS. 44 and 46), the user interface 520 is accessible only from an interface relating to a specific underwriting so that the withdrawal process is automatically linked to the appropriate underwriting. As will be seen from FIG. 48, the interface 520 is preferably selected by means of a tab 522 which is one of four tabs which appear in the same screen, the others being a tab 524 for ad hoc transactions, a tab 526 for adjustments and a tab 528 for accessing an interface for setting up arrears procedures.

The user interface 520 comprises a field 529 for indicating the date from which the income should start. The field 529 corresponds to the field 503, labelled IncomeFrom, in table 500. Fields 530 and 531 are for entering respectively the amount of money which is to be drawn from capital and the amount of money to be drawn by selling fund units, when the automatic withdrawal process is executed. The fields 530 and 531 correspond respectively to the fields 504 and 506, labelled Capital and Index, in table 500. A drop down menu 533 is for selecting from a list of rules to be applied to the automatic withdrawal process. Each rule on this list corresponds to a respective different instance of table 516.

The setting up of an automatic withdrawal process is begun by entering the required data into fields 529, 530 and 531, and selecting a rule using the drop down menu 533. Pressing button 536 in user interface 520 creates a new line in panel 535 (or the first line thereof if it is the first auto withdrawal process to be set up for the underwriting in question) and causes the data in fields 529, 530 and 531 also to be entered into fields 537, 538 and 539 in the new line of panel 535. The field 540 displays the name of the rule to be followed in the automatic withdrawal process, as selected from the drop down menu 533.

Panel 541 is provided in user interface 520 for defining, in processes in which money is to be made available by selling fund units, which fund units are to be sold, the priority to be given to the respective funds and the percentage or monetary amount to be realised from sale of units in each respective fund.

A drop down menu 542 is provided giving a list of available funds. Selecting a fund from this list activates fields 543, 544 and 545 to permit entry of data defining the priority to be given to withdrawal from the selected fund and the amount, by percentage or monetary value, to be realised by selling units in that fund. Button 546 is provided to confirm the selection. Pressing this button creates a new line 547 in panel 541 containing the name of the selected fund and the data which has been entered using fields 543, 544 and 545, this data appearing in the correspondingly named fields in line 547. Each new line 547 in panel 541 accordingly corresponds to a respective different instance of table 508. The fields in table 508 in FIG. 47 labelled Priority, Percentage and Amount are designated by the reference numbers 543, 544 and 545 so as to indicate the correspondence with the data entered into the fields 543, 544 and 545 in FIG. 48.

If the user decides to apply the auto withdrawal process defined in panels 535 and 541, he selects a scheduled pipeline process for the performance of the transactions, using an appropriate interface (not shown), and this process will define the intervals at which the automatic withdrawal process will be executed.

If a number of different automatic withdrawal processes have been setup and/or applied to the same underwriting, the data defining these processes will be displayed in panel 35 whenever this user interface is accessed.

Additional Fields

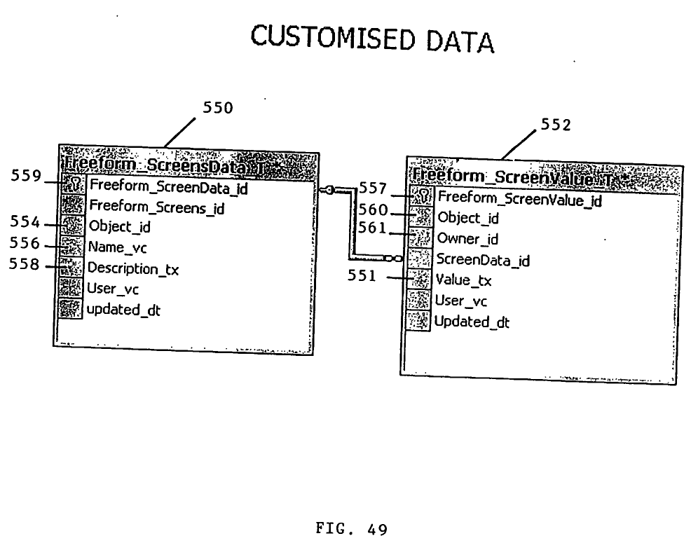

FIG. 49 illustrates a facility for providing additional fields for the tables of any of the objects which have been described above. This facility comprises two tables 550 and 552 which are shown in FIG. 49 and a user interface (which is not shown and need not be described) for entering data into these tables.

The table 550 contains a field 554 which is for storing the identity of the object for which the new field is to be provided. As indicated already, this may be any of the previously described object, such as the address object or the mortgage object etc.. A new instance of table 550 is accordingly created for each object for which a new field of fields is all are to be provided. Field 556 in table 550 is for naming the new field and field 558 is for storing a description of it. The fields labelled User and Updated are for the purposes previously described.

The new field, which is identified by the reference number 551, is not contained in table 550 but, instead, is in table 552. A separate instance of table 552 is created for each new field for a given instance of a given object and is linked to the instance of table 550 which has been created for that object by identification data in the field 556 of table 552 and field 559 of table 550. The identities of the object and the specific instance thereof to which each instance of table 552 relates are stored in fields 560 and 561 respectively. Accordingly, in order to create a new field for a given instance of a given object, instances of the tables 550 and 552 are created. The value of the data to be contained in the new field is then stored in field 551 of table 552. The new data can be used by setting up a pipeline process which requires it and/or modifying existing pipeline processes to utilise it.

Distributed Systems

In the embodiment of the invention described reference to the drawings, the mortgage management program has all of its components stored on the same server computer. This is not essential. Different components could be provided on different computers in communication with each other over a suitable communication channel of channels.

Further, it would be possible to create an embodiment of the invention in which one or more parts of the database are external. For example, instead of storing in the system fund unit prices it would be possible to dispense with the fund price object and provide in the program a module which obtains fund prices as and when required from external publicly accessible databases. For example, historical values, as well as the current value, of the FT-SE 100 index and share prices are available over the internet.

Linking to Separate Mortgage or Investment Management Systems

The program 12 as described with reference to FIGS. 1 to 50 is a complete system in that it has facilities for storing all data required and includes all of the functionality necessary for setting up and administering a wide variety of different mortgages, especially, as explained, complex offset-type mortgages.

The invention could alternatively be implemented in a manner which makes use of some or all of the components of a separate computer implemented mortgage management system and/or some or all of the components of a separate computer implemented financial investment management system handling investments in a variety of different funds. If the invention is implemented in this way, a number of the objects and/or tables described with reference to FIGS. 1 to 50 could be omitted and, as appropriate, the program may contain processing components, for example implemented by means of tasks in component 24, for obtaining data from and sending data to the separate mortgage system and/or investment system.

For example, an embodiment of the invention for use with a separate mortgage management system could omit the objects shown in FIG. 2 and the mortgage object M and the interest rate object IR shown in FIG. 3. In such an embodiment, mortgage arrangements would be defined and managed utilising the remaining objects in the manner already described, but with data being sent to and received from the mortgage system to which the embodiment of the invention would be linked whenever required. As a modification to this embodiment, the underwriting object U might also be omitted and underwritings defined within the mortgage system to which the embodiment of the invention is linked.

By way of further example, an embodiment of the invention for use with a separate investment system might omit the fund investment basis object FI. The payment target object PT, in this example, would still be used for specifying the distribution of payments as between capital, interest, penalty interest and funds. Data defining the sum to be used for purchase of funds would then be sent by appropriate functional components of the program to the computer implemented investment system and the distribution of this as between different funds would be determined by facilities within the fund investment system. If a transaction is to be implemented in which fund units are to be sold, the payment target object PT may be employed in determining, as described with reference the drawings, the amount to be realised by the sale and data defining this is sent, by appropriate functional components of the program, to the investment management system which would have facilities for determining the spread of units amongst various funds to be sold to realise the amount required.

The fund price object FP might also be omitted and fund prices might then be obtained from the investment management system(or otherwise as already discussed above).

By way of further example, an embodiment of the invention might be constructed with modifications as described in the preceding paragraphs for linkage both to a separate computer implemented mortgage management system and to a separate computer implemented fund investment management system.

In embodiments in which use is made of some or all of the components of a separate computer implemented mortgage management system and/or investment management system, the transaction database might also be omitted from the embodiment of the invention and data stored in one or more transaction databases provided in the separate mortgage management system and/or separate investment management system, as the case may be. Data required for the execution of transactions, or resulting from transactions may then be transferred to and from the transaction database or databases as required. It is preferred, however, that data relating to transactions should be stored as described above to facilitate processing operations and calculations in the manner explained above.

The above referred to separate mortgage management and/or investment management systems may be installed on the same computer as the invention or may be installed on one or more different computers, in which case data transmission between the invention and those systems may be achieved via any suitable transmission link, such as the Internet.

Any separate mortgage management system or investment management system to which the invention is linked may be a pre-existing system.

### ADDITIONAL PROCESSES AND PROCEDURES

Automatic Termination of Mortgage

Preferably, a scheduled pipeline process is set up so as to calculate, on a regular and relatively frequent basis, the current values of the assets and liabilities for each mortgage. These calculations may be made in the manner already described above. If this calculation reveals that, in any mortgage, the value of the assets exceeds that of the liabilities, the program 12 may automatically terminate that mortgage and payout any balance to the mortgagee after fund units have been sold to pay all outstanding borrowings (capital and interest).

Automatic Payment of Commission

Pipeline processes may be set up to pay commission to brokers, using customised data fields, for example created utilising the tables described with reference to FIG. 49. The commission may be based upon the value of any transactions involving units. Since different brokers may have different procedures and requirements, the pipeline processes and the data they utilise may be tailored to meet these procedures and requirements for individual brokers as necessary. These procedures could be set up in relation to individual mortgages or alternatively they could be setup in relation to one or more of the predefined products.

Automatic Payment of Insurance Premiums

Mortgagees commonly require insurance to cover outstanding liabilities or future payment to the mortgage company in the event of death or other events. Mortgages which are managed by the system of the present invention and which have sums of money linked to fund units of varying value consequently have a net liability which is continually varying as a result of changes in the price of the units in the different funds. Since insurance premiums depend upon the amount of money insured, the level of premium appropriate to insure the outstanding liabilities in an offset mortgage of this kind will vary. Since, in the preferred embodiment of the present invention the amount of the net outstanding liability can be easily and quickly calculated, as described above, it would be possible to setup additional pipeline processes for calculating the current correct amount of insurance premium necessary for ensuring the current level of their liability. The pipeline process could be set up so as automatically to draw the correct premium amount, either by selling fund units and or by drawing down additional capital, and to remit the premium to an insurance Company. These processes could be executed monthly, for example.

Provision of Reports

It will be understood from the foregoing description that is extremely easy to calculate current liabilities and assets. As a consequence, the creation of reports and statements (which may be displayed or printed) tailored to particular requirements is greatly facilitated by the structure and functionality of the preferred embodiment of the present invention, especially the structure of the transaction database.

One requirement might be for the production of a report, at regular intervals, giving the current total value of the units held by all underwritings in each fund. Such a report can easily be produced, at least in preferred embodiments of the invention. For example, if the transaction database is as illustrated in FIG. 8, the total value of the units held by the system as a whole in a given fund can be calculated simply by summing the numbers in column 42 which relate to the fund in question as identified by the fund ID data in column 40. The resulting total number of units for that fund is then multiplied by the current unit value which is obtained from the fund price object FP. This can be repeated for each fund ID in column 40 of the transaction database so as to obtain the respective total value of the units held in the system in each different fund. A report of this kind might be used by the mortgagor as an aid to making investments to provide a hedge against variations in value of external funds or indices to which the price of the internal fund units is linked. For example, the mortgagor might make actual investments to the appropriate value in the external funds to which the unit prices of the internal funds are linked.

Many countries have regulations governing the conduct of financial institutions. The regulations may require a production of reports and statements regarding the business performed by the institution. It will be readily appreciated that, released in the preferred embodiments of the invention as described above, reports and statements in any of a wide variety of different forms can be created since the financial data which relates to the numerous transactions which will have taken place in the mortgage system in accordance with invention will be readily available from transaction database.

Alternative Forms of Loan

Although the embodiment of the invention which has been described has been for the management of mortgages, the invention is also applicable to the management of other forms of loan, such as bank overdraft arrangements. The invention thus makes it possible for a variety of such overdraft arrangements, or other loans, to be set up and managed in which offsetting of the amount borrowed against fund units may be managed in the manner described in relation to mortgages.

Alternative Means of Using the Transaction Database

It is possible to use the system as designed and dispense with the use of unit prices.

In such circumstances all units held in respect of any one underwriting object U are assumed to have a monetary value of 1 which never changes. Any movement in the value of each fund internally linked to any one underwriting object U which would otherwise have been represented by changes in its unit price are now instead replaced by an appropriate unit transaction wherein units are added or subtracted so that the now resulting aggregate number of units is equal to the new value of the internally linked fund.

In order to provide a complex offset mortgage economically the same as those already described previously it will be necessary to do the following:
1. For each and every underwriting object U calculate the daily movement in the value of its internally linked funds and apply a new transaction for each fund as described above. Daily transactions are needed, in practice, to ensure that the lending company can keep an accurate and up to date account of its unit liabilities.
2. All other transactions, involving units, can only occur at the time of the daily calculation described in 1 above.
3. In order to avoid serious rounding problems the number of units internally linked to any one underwriting object U in respect of any one fund cannot be rounded to less than 4 places of decimal and in practice would not normally be less than 8. Alternatively the value of any one unit can be set to be equal to a small number e.g. 1/10000 of a penny and units can be rounded to 1 or 2 places of decimal.

### APPENDIX

The following is an example of a simple formula which may be used in the payment review process, referred to above in the description of detailed example of the payment review basis object shown in FIG. 24:

$$\frac{{L}_{t} - {F}_{t}}{{S}_{n}} = {A}^{R}$$

Payment=I (to cover interest) +C (to repay capital) +A (allocated to funds)
A^{R}=Review result for the revised value of A

### APPENDIX CONTINUED

Lₜ=predicted value of liabilities (capital, accrued interest less paid interest, penalty interest plus redemption penalty) at future date t, allowing for future payments until this date, their allocation (under the payment target basis), the assumed interest rate accruing on capital etc.
t=some future date, the point in time to which the review is being made.
n=number of years and past years from the date at which the review is being carried out until date t.

### APPENDIX CONTINUED

Fₜ=predicted value of assets at future date t allowing for the current value of assets, an average annual future growth rate 9% (possibly determined separately for each fund link) allowing for the effects of such things as the auto switch basis where 9% is derived from such items as the funds ERP (after any adjustments) and the appropriate assured risk free rate.
[symbol] Sn=compound interest accrual function at rate 9% allowing for the allocation, payment target and fund investment bases.
PAYMENT=A^{R}−A
INCREASE Similar formulae can be developed to determine C^{R} (Revised capital element of the payment) if it is required to keep A constant and vary C.

### APPENDIX CONTINUED

p^{R}=I+C+A^{R} or
p^{R}=I+C^{R}+A

1. A computer system for the management of loans comprising: loan definition means for defining a plurality of loans; means for storing liability values relating to said respective loans; fund definition means for defining a plurality of different funds; unit storage means for storing, in relation to each said defined loan, a plurality of numbers each representing a number of units; means for linking said numbers of units to selected ones of said defined funds, said linking means enabling said numbers stored in relation to different loans to be linked to different combinations of said defined funds; price storage means for storing prices of said units in relation to said defined funds; transaction means operable to utilise said unit prices in performing, in relation to said loans, first transactions in which monetary values are converted to numbers of units and applied to said unit storage means, and second transactions in which numbers of units stored in said unit storage means are converted to monetary values.

2. A system according to claim 1, comprising at least one control data storage means adapted to store a plurality of different values of control data for controlling said transactions, and means for linking said different values of said control data to respective different ones of said defined loans, said transaction means being operable to perform transactions in relation to said loans utilising the values of said control data linked thereto, so that a transaction may be performed differently, according to the values of the control data, when performed on different loans.

3. A system according to claim 2, wherein said, or one of said, control data storage means is adapted for storing transaction control data which controls distribution of a monetary value between an amount to be credited against said liabilities and an amount to be utilised in a said first transaction.

4. A system according to claim 2, in which said, or one of said, control data storage means is adapted for storing transaction control data which controls distribution of a monetary value for conversion to numbers of units relating to different ones of said funds identified by said control data.

5. A system according to claim 2, in which said, or one of said, control data storage means is adapted for storing transaction control data controlling the selection of interest rates to be applied in relation to said loans.

6. A system according to claim 2, in which said, or one of said, control data storage means is adapted for storing transaction control data controlling the selection of penalty interest rates to be applied in relation to said loans.

7. A system according to claim 2, in which said, or one of said, control data storage means is adapted for storing transaction control data for controlling a transaction in which, in response to a predetermined condition, at least some units in an existing distribution thereof in relation to said funds are converted at least partly to a monetary value.

8. A system according to claim 7, in which said control data storage means is adapted for storing data for controlling a reconversion of at least part of said monetary value to units to create a new distribution of units in relation to defined

9. A system according to claim 2, in which said, or one of said, control data storage means is adapted to store transaction control data for controlling a process which determines whether or not a current value for regular payments to pay off the loan meets predetermined criteria relating to said funds and said liabilities.

10. A system according to claim 2, in which said, or one of said, control data storage means is adapted to store transaction control data which controls distribution of bonus payments or costs as between liabilities and said units.

11. A system according to claim 2, in which said, or one of said, control data storage means is adapted for storing transaction control data controlling computation of the cost of redeeming said loan at different points in the period of the loan.

12. A system according to claim 3, wherein said control data comprises time control data defining the time at which, following a predetermined date relating to a new loan, the values of the transaction control data therein should become effective.

13. A system according to claim 11, wherein said control data storage means is adapted to store a plurality of different values for said time control data and a plurality of different values for said transaction control data so that different values of said transaction control data may be made effective at different times following said predetermined date.

15. A system according to claim 2, wherein the or each said control data storage means is adapted to store validity control data defining a date after which the transaction control data stored therein may be linked to loans set up thereafter.

14. A system according to claim 2, comprising product definition means for predefining a plurality of different predefined products having different values of the control data.

16. A system according to claim 15, in which said product definition means comprises means for pre-defining in relation to each product one or more processes to be performed in accordance with a schedule.

17. A system according to claim 1 comprising schedule means for defining the performance, by said transaction means, of predetermined transactions in accordance with a predetermined schedule and means for linking respective schedules to respective different ones of said defined loans.

18. A system according to claim 1, including means for instructing, by user command, a processing operation involving a said first transaction, said instructing means including means for specifying values of control data which controls the distribution of the monetary value between different said funds.

19. A system according to claim 1, including means for instructing, by user command, a processing operation involving a said second transaction, said instructing means including means for specifying values of control data which controls the distribution of the monetary value between different said funds.

20. A system according to claim 1, including means for instructing, by user command, a processing operation which comprises at least one of said first transactions and at least one of said second transactions, said instruction means permitting values for control data to be specified which controls the monetary distribution in each of said transactions.

21. A system according to claim 1, comprising a transaction database for storing data relating to each individual said transaction performed by the system, said transaction data including the number of fund units transacted, the identity of the fund to which they relate and the identity of the loan to which they relate.

22. A system according to claim 19, comprising processing means for computing the current value of units linked to respective said loans by summing the number of units in the transaction database which relate to the same loan and the same fund and calculating their current value utilising the current price thereof stored in said price storage means.

23. A system according to claim 1, comprising means for storing, in relation to each said loan, the current total of units linked to each respective said fund.

24. A system according to claim 1, comprising means defining a process for computing in relation to each said loan, the current value of the liabilities and the current total value of the units linked to the respective loan.

25. A system according to claim 24, wherein said computing process is operable to compute the balance of the current value of liabilities and the current total value of the units linked to the loan.

26. A system according to claim 2, wherein said control data storage means is adapted for storing control data defining distributions in transactions involving units, on the basis of monetary value of said units and on the basis of the number of units.

27. A system according to claim 2, wherein said control data storage means is adapted for storing control data for assigning priorities to respective different funds in relation to transactions involving units in a plurality of funds.

28. A computer system for the management of loans comprising: means for defining a plurality of loans; means for defining a plurality of funds; means for storing a plurality of numbers; means for linking each of said numbers to both a selected one of said defined loans and a selected one of said defined funds; means for storing unit values relating respectively to said funds; means for recording monetary values relating to said respective defined loans; means for converting said monetary values to fund units utilising said stored fund unit value; means for converting the total number of units linked to the same loan and the same fund to a monetary value which may be offset against the loan.

29. A computer system for the management of loans comprising: means for defining a plurality of loans; means for recording monetary values relating to said respective defined loans; means for defining a plurality of funds; means for converting said monetary values to numbers, representing respectively numbers of fund units, utilising said stored fund unit value; means for linking each of said numbers to said at least one fund and to both the corresponding defined loan and the corresponding defined fund; means for converting the total number of units linked to the same loan and the same fund to a monetary value which may be offset against the loan.

30. A computer system for the management of loans comprising: asset definition means for defining at least one fund and for storing in relation thereto a fund unit value; loan definition means for defining a plurality of loans, said loan definition means comprising: liability storage means for storing liability values representing the outstanding amount of the loan and outstanding interest, asset storage means for storing assets in the form of units relating to each of at least one fund; and monetary value recording means for recording relating to transactions in respect of said loan; transaction means for performing transactions in relation to said loans, said transaction means comprising: means for converting said monetary values relating to transactions into numbers of fund units utilising said fund unit value; and means for storing said number of units calculated by said conversion means in said asset storage means of said corresponding loan; means for converting, in relation to each respective defined loan, the total number of units stored in the asset storage means thereof to a monetary value to provide a monetary value for said assets.

31. A computer system for financial management comprising: asset definition means which comprises, fund definition means for defining a plurality of different funds representing assets, and fund unit price definition means for storing a fund unit price in relation to each said defined fund loan definition means for defining a plurality of loans, said loan definition means comprising, liability storage means for storing liability values representing the outstanding amount of the loan and outstanding interest, a plurality of fund unit storage means each for storing a number representing a number of fund units; and monetary value recording means for recording monetary values relating to transactions in respect of said loan; selection means operable for linking selected ones of said fund unit storage means to selected ones of said defined funds such that the fund unit storage means of different loans may be linked to different combinations of said funds; transaction means for performing transactions in relation to said loans, said transaction means comprising: means for converting said monetary values relating to transactions into numbers of fund units utilising said fund unit value; and means for storing said number of units calculated by said conversion means in said fund unit storage means of said corresponding loan; means for converting, in relation to each respective defined loan, the total number of units stored in each respective one of said fund unit storage means thereof to a monetary value utilising the current unit price of said fund.

32. A loan management system substantially is herein described with reference to the accompanying drawings.

33. A system according to claim 1 arranged for managing mortgages.

34. A method of lending money which comprises recording liabilities relating to capital and interest, recording at least one asset having a value which increases and decreases in value as a function of a selected index, and, at least on one occasion, offsetting the value of the asset against the value of the liabilities.

35. A method according to claim 34, which comprises recording a plurality of said assets each having a value which increases and decreases as a function of a respective different selected index, and wherein, on said at least one occasion, the total value of said assets is offset against the value of the liabilities.

36. A method according to claim 34, which comprises performing said method in relation to a plurality of different loans and a plurality of different said assets, with different set assets being related to different said loans.

37. A method according to claim 35, which comprises performing said method in relation to a plurality of different loans and a plurality of different said assets, with different set assets being related to different said loans.
